SEQUENCE LISTING (2 sequences)

SEQ ID NO: 1 - DNA, 738 bp, Artificial Sequence
  modified Protein A
atggccaccaaagctagcaaagtagacaacaaattcaacaaagaacaacaaaatgctttctatgaaatcttacatttacctaacttaaccgaagaacaacgcaatgctttcatccaaagcctaaaagatgacccaagcgtgagcaaagaaatcttagcagaagctaaaaagctaaatgatgcacaagctccaaaagaattcgtggataacaaattcaacaaagaacaacaaaatgctttctatgaaatcttacatttacctaacttaaccgaagaacaacgcaatgctttcatccaaagcctaaaagatgacccaagcgtgagcaaagaaatcttagcagaagctaaaaagctaaatgatgcacaagctccaaaagaattcgtggataacaaattcaacaaagaacaacaaaatgctttctatgaaatcttacatttacctaacttaaccgaagaacaacgcaatgctttcatccaaagcctaaaagatgacccaagcgtgagcaaagaaatcttagcagaagctaaaaagctaaatgatgcacaagctccaaaagagctcgtggataacaaattcaacaaagaacaacaaaatgctttctatgaaatcttacatttacctaacttaaccgaagaacaacgcaatgctttcatccaaagcctaaaagatgacccaagcgtgagcaaagaaatcttagcagaagctaaaaagctaaatgatgcacaagctccaaaatag

SEQ ID NO: 2 - protein, 245 aa, Artificial Sequence
  Synthetic Construct
MATKASKVDNKFNKEQQNAFYEILHLPNLTEEQRNAFIQSLKDDPSVSKEILAEAKKLNDAQAPKEFVDNKFNKEQQNAFYEILHLPNLTEEQRNAFIQSLKDDPSVSKEILAEAKKLNDAQAPKEFVDNKFNKEQQNAFYEILHLPNLTEEQRNAFIQSLKDDPSVSKEILAEAKKLNDAQAPKELVDNKFNKEQQNAFYEILHLPNLTEEQRNAFIQSLKDDPSVSKEILAEAKKLNDAQAPK

(19) United States
(12) Patent Application Publication
(10) Pub. No.: US 2017/0043320 A1
(43) Pub. Date: Feb. 16, 2017

(54) SOLID-PHASE CARRIER, PRODUCTION METHOD FOR SOLID-PHASE CARRIER, CARRIER FOR AFFINITY REFINING, PRODUCTION METHOD FOR FILLER FOR AFFINITY CHROMATOGRAPHY, FILLER FOR AFFINITY CHROMATOGRAPHY, CHROMATOGRAPHY COLUMN, AND REFINING METHOD

(71) Applicants: JSR CORPORATION, Tokyo (JP); JSR LIFE SCIENCES CORPORATION, Tokyo (JP)

(72) Inventors: Masaki MOMIYAMA, Minato-ku (JP); Sachiko TSUDA, Minato-ku (JP); Yusuke OKANO, Minato-ku (JP); Tomonori SHIOTANI, Minato-ku (JP); Yuko KAWADA, Minato-ku (JP); Ryou TSUDA, Minato-ku (JP); Hiroshi KAWAI, Minato-ku (JP)

(73) Assignees: JSR CORPORATION, Tokyo (JP); JSR LIFE SCIENCES CORPORATION, Tokyo (JP)

(21) Appl. No.: 15/038,919

(22) PCT Filed: Nov. 27, 2014
(86) PCT No.: PCT/JP2014/081302

§ 371 Date: Aug. 26, 2016

(30) Foreign Application Priority Data
Nov. 27, 2013 (JP) 2013-244848
Jun. 27, 2014 (JP) 2014-132610

(51) Int. Cl. B01J 20/289; B01D 15/38; G01N 30/02; B01J 20/32

(52) U.S. Cl. CPC B01J 20/289; B01J 20/321; B01J 20/3219; B01J 20/3274; B01D 15/3804; G01N 30/02

(57) ABSTRACT

There are provided a solid-phase carrier and a carrier for affinity refining that exhibit high dynamic binding capacity when a ligand is immobilized, have excellent antifouling properties, and are unlikely to have non-specific adsorption of impurities. The solid-phase carrier has a functional group capable of fixing a ligand and is characterized by having a group having a sulfinyl group, a sulfide group, an oxy group or an imino group, and a hydroxyl group, a thiol group, an amino group, a carboxy group, a sulfate group, a phosphate group or an alkanoyl group.

### TECHNICAL FIELD

The present invention relates to a solid-phase carrier, a method for producing a solid-phase carrier, a carrier for affinity refining, a method for producing a filler for affinity chromatography, a filler for affinity chromatography, a chromatography column, and a refining method.

### BACKGROUND ART

Affinity chromatography plays a key role in the research, development, and production of proteins including monoclonal antibodies. A carrier for affinity refining to be used for affinity chromatography generally contains a solid-phase carrier having a ligand that selectively binds to a target substance, and a reactive group for binding this ligand. Since the ligand on the solid-phase carrier used in affinity chromatography exhibits high selectivity to the target substance, the affinity chromatography enables economic refining with an excellent yield and at a high speed, as compared to other chromatographic techniques such as ion chromatography, gel filtration chromatography, and reverse phase liquid chromatography.

Generally, as the performance required in affinity chromatography for protein refining, performance that is unlikely to have non-specific adsorption of impurities other than a target protein, or performance that exhibits dynamic binding capacity with respect to a target protein corresponding to a ligand when the ligand is immobilized, or the like is exemplified.

Under such circumstances, it is proposed to use agarose particles (Patent Literatures 1 and 2), porous particles consisting of a copolymer of styrene-divinylbenzene (Patent Literatures 3 and 4), and porous particles consisting of a polymer of a methacrylate-based vinyl monomer (Patent Literatures 5 and 6), as a solid-phase carrier of a carrier for affinity refining.

### CITATION LIST

### Patent Literature

Patent Literature 1: JP 2008-523140 W

Patent Literature 2: JP 2009-522580 W

Patent Literature 3: JP 08-278299 A

Patent Literature 4: JP 10-501173 W

Patent Literature 5: WO 2011/125674 A

Patent Literature 6: JP 2012-141212 A

### SUMMARY OF INVENTION

### Technical Problem

Under such circumstances as described above, it is an object of the present invention to provide a solid-phase carrier and a carrier for affinity refining that exhibit high dynamic binding capacity when a ligand is immobilized, have excellent antifouling properties, and are unlikely to have non-specific adsorption of impurities.

### Solution to Problem

In this regard, the present inventors carried out an extensive investigation and, as a result, they found that a solid-phase carrier, which has a group having a sulfinyl group, a sulfide group, an oxy group or an imino group, and a hydroxyl group, a thiol group, an amino group, a carboxy group, a sulfate group, a phosphate group or an alkanoyl group in addition to a functional group capable of fixing a ligand, has excellent antifouling properties and exhibits high dynamic binding capacity when a ligand is immobilized. Thus, they accomplished the present invention.

In addition, the present inventors carried out an extensive investigation and, as a result, they found that a carrier for affinity refining, which has a solid-phase carrier comprising a high-molecular-weight compound with a specific terminal structure through a thio group, a sulfinyl group or a sulfonyl group, has excellent antifouling properties and exhibits high dynamic binding capacity when a ligand is immobilized. Thus, they accomplished the present invention.

That is, the present invention is to provide <1> a solid-phase carrier having a functional group capable of fixing a ligand, the solid-phase carrier characterized by having a group having a sulfinyl group, a sulfide group, an oxy group or an imino group, and a hydroxyl group, a thiol group, an amino group, a carboxy group, a sulfate group, a phosphate group or an alkanoyl group (hereinafter, this solid-phase carrier is also referred to as the solid-phase carrier A).

Further, the present invention is to provide <2> a method for producing a solid-phase carrier having a functional group capable of fixing a ligand and a group represented by the following Formula (5-1), (5-2) or (5-3), the method including a step of bringing a solid-phase carrier having a functional group capable of fixing a ligand into contact with a compound represented by the following Formula (4) (hereinafter, this production method is also referred to as the production method B).

R²—Y—H (4)

[In Formula (4),

R² represents a monovalent organic group having 1 to 10 carbon atoms, and

Y represents a sulfide group, an oxy group or an imino group.]

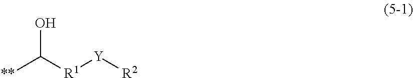

[In Formula (5-1),

R¹ represents a divalent hydrocarbon group having 1 to 6 carbon atoms,

** represents a bond, and

R² and Y have the same meaning as defined above.]

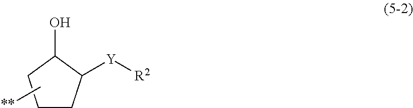

[In Formula (5-2), R², Y, and ** have the same meaning as defined above.]

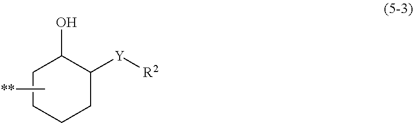

[In Formula (5-3), R², Y, and ** have the same meaning as defined above.]

Further, the present invention is to provide <3> a method for producing a filler for affinity chromatography, the method including a step of fixing a ligand to the solid-phase carrier described in the above <1> or a solid-phase carrier produced by the production method described in the above <2> (hereinafter, this production method is also referred to as the production method C).

Further, the present invention is to provide <4> a filler for affinity chromatography, obtained by the production method described in the above <3>.

Further, the present invention is to provide <5> a carrier for affinity refining, the carrier having a solid-phase carrier and a ligand or a reactive group for binding a ligand, characterized in that

the ligand or the reactive group for binding a ligand is bound to the solid-phase carrier, and

a polymer comprising the solid-phase carrier has a terminal structure having at least one group selected from a hydroxyl group, a thiol group, a carbonyl group, an amino group, a thio group, a disulfide group, a sulfinyl group, a sulfonyl group, a carboxy group, a sulfate group, and a phosphate group, in the terminal of the chain through a thio group, a sulfinyl group or a sulfonyl group (hereinafter, this carrier for affinity refining is also referred to as the carrier D for affinity refining).

Further, the present invention is to provide <6> a filler for a chromatography column including the carrier for affinity refining described in the above <5> as a carrier.

Further, the present invention is to provide <7> a chromatography column being obtained by filling a column container with the filler described in the above <4> or <6>.

Further, the present invention is to provide <8> a method for refining a target substance, the method including:

a step of preparing a composition containing the target substance; and

a step of causing the composition to pass through the chromatography column described in the above <7>.

### Advantageous Effects of Invention

The solid-phase carrier A of the present invention has excellent antifouling properties and is unlikely to have non-specific adsorption of impurities such as a host cell protein (HCP). Moreover, the solid-phase carrier A exhibits high dynamic binding capacity when a ligand is immobilized.

Further, the carrier D for affinity refining of the present invention has excellent antifouling properties and is unlikely to have non-specific adsorption of impurities such as a host cell protein (HCP). Moreover, the carrier D for affinity refining exhibits high dynamic binding capacity when a ligand is immobilized.

Therefore, the filler for affinity chromatography and the chromatography column of the present invention have large dynamic binding capacity of a target substance corresponding to the ligand, and excellent antifouling properties.

Further, according to the production method B of the solid-phase carrier of the present invention and the production method C of the filler for affinity chromatography of the present invention, a solid-phase carrier and a filler for affinity chromatography having performances as described above can be simply produced.

### BRIEF DESCRIPTION OF DRAWINGS

FIG. 1 is a diagram illustrating an example of a method for producing a solid-phase carrier of the present invention.

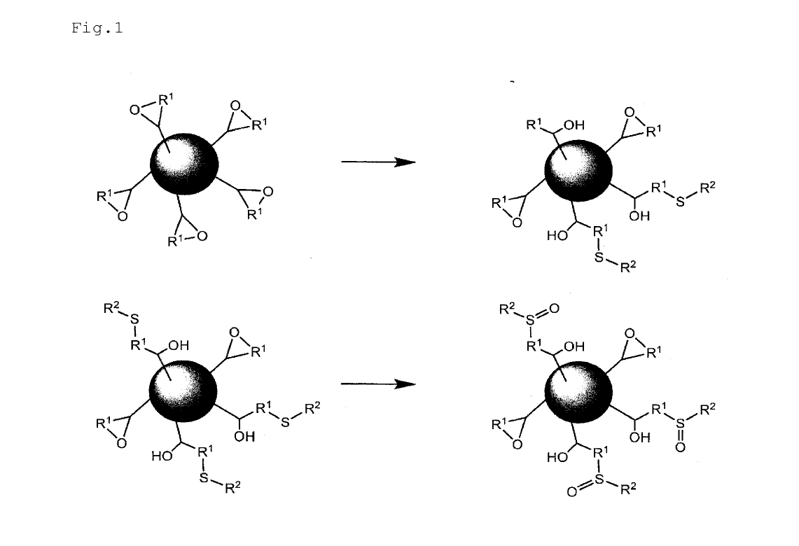

FIG. 2 is a diagram illustrating an example of a method for producing a filler for affinity chromatography of the present invention.

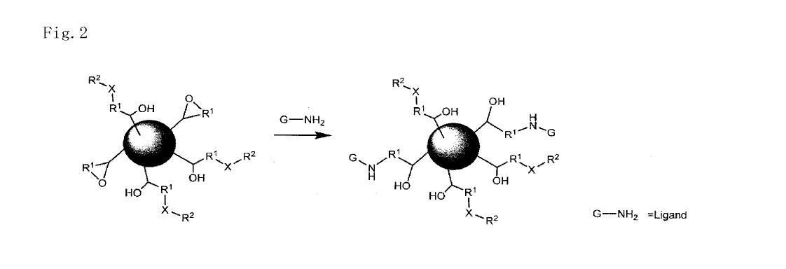

### DESCRIPTION OF EMBODIMENTS

### Solid-Phase Carrier A

The solid-phase carrier A of the present invention is characterized by having a group having a sulfinyl group (>S(═O)), a sulfide group (> S), an oxy group (>O) or an imino group (>NH) and a hydroxyl group (—OH), a thiol group (—SH), an amino group (—NH₂), a carboxy group (—COOH), a sulfate group (—OS(═O)₂(OH)), a phosphate group (—OP(═O) (OH)₂) or an alkanoyl group in addition to a functional group capable of fixing a ligand. The alkanoyl group may be a linear chain or a branched chain, and the number of carbon atoms thereof is preferably 2 to 10, more preferably 2 to 6, and particularly preferably 2 to 4. Examples of the alkanoyl group include an acetyl group, a propionyl group, a butyryl group, and a valeryl group.

Further, in the solid-phase carrier A of the present invention, the ligand may not be fixed to the functional group capable of fixing a ligand.

Examples of the functional group capable of fixing the ligand include a cyclic ether group, a carboxy group, a succinimidoxy group, a formyl group, an isocyanate group, and an amino group. Among these, a cyclic ether group is preferable, a cyclic ether group having 3 to 7 atoms that form a ring is more preferable, a group represented by the following Formula (1-1), (1-2) or (1-3) is even more preferable, and a group represented by the following Formula (1-1) is particularly preferable.

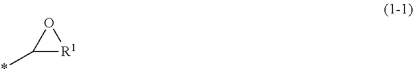

[In Formula (1-1),

R¹ represents a divalent hydrocarbon group having 1 to 6 carbon atoms, and

* represents a bond.]

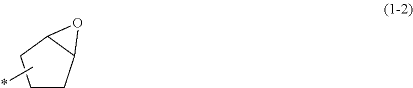

[In Formula (1-2), *has the same meaning as defined above.](1-3)

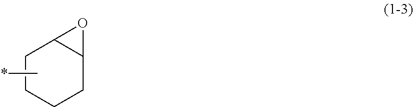

[In Formula (1-3), * has the same meaning as defined above.]

In Formula (1-1), R¹ represents a divalent hydrocarbon group having 1 to 6 carbon atoms. The number of carbon atoms of such a divalent hydrocarbon group is preferably 1 to 4, more preferably 1 or 2, and particularly preferably 1. Further, the divalent hydrocarbon group may be a linear chain or a branched chain.

Further, the divalent hydrocarbon group is preferably a divalent aliphatic hydrocarbon group and more preferably an alkanediyl group. Preferred specific examples thereof include a methane-1,1-diyl group, an ethane-1,1-diyl group, and an ethane-1,2-diyl group.

Further, the solid-phase carrier A of the present invention has a group having a sulfinyl group, a sulfide group, an oxy group or an imino group, and a hydroxyl group, a thiol group, an amino group, a carboxy group, a sulfate group, a phosphate group or an alkanoyl group. Among a hydroxyl group, a thiol group, an amino group, a carboxy group, a sulfate group, a phosphate group, and an alkanoyl group, from the viewpoint of dynamic binding capacity when a ligand is immobilized and antifouling properties, a hydroxyl group, a thiol group, a carboxy group, a sulfate group, and an alkanoyl group are preferable, a hydroxyl group, a carboxy group, and a sulfate group are more preferable, and a hydroxyl group is particularly preferable. Preferred specific examples of the group having a sulfinyl group, a sulfide group, an oxy group or an imino group, and a hydroxyl group include a group represented by the following Formula (2-1), (2-2) or (2-3), and a group represented by the following Formula (2-1) is particularly preferable.

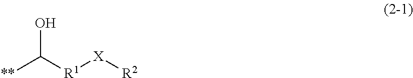

[In Formula (2-1),

R² represents a monovalent organic group having 1 to 10 carbon atoms,

X represents a sulfinyl group, a sulfide group, an oxy group or an imino group,

** represents a bond, and

R¹ has the same meaning as defined above and represents a divalent hydrocarbon group having 1 to 6 carbon atoms.]

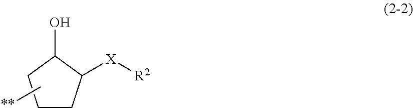

[In Formula (2-2), R², X, and ** have the same meaning as defined above.]

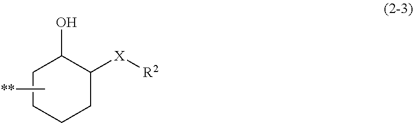

[In Formula (2-3), R², X, and ** have the same meaning as defined above.]

In Formulae (2-1) to (2-3), X represents a sulfinyl group, a sulfide group, an oxy group or an imino group, and from the viewpoint of antifouling properties, X is preferably a sulfinyl group, a sulfide group or an oxy group, and particularly preferably a sulfinyl group.

Further, in Formulae (2-1) to (2-3), R² represents a monovalent organic group having 1 to 10 carbon atoms. The number of carbon atoms of such a monovalent organic group is preferably 1 to 8, more preferably 1 to 6, and even more preferably 2 to 4, from the viewpoint of dynamic binding capacity when a ligand is immobilized and antifouling properties.

Further, examples of the monovalent organic group include a monovalent hydrocarbon group, a group in which at least one or more hydrogen atoms contained in the monovalent hydrocarbon group are substituted with a hydrophilic group, and —(R⁶O)ₘ—H (R⁶ represents an alkanediyl group having 2 to 4 carbon atoms and m represents an integer of 1 to 50). These may be a linear chain or a branched chain.

The monovalent hydrocarbon group encompasses the concept including a monovalent aliphatic hydrocarbon group, a monovalent alicyclic hydrocarbon group, and a monovalent aromatic hydrocarbon group. A monovalent aliphatic hydrocarbon group is preferable and an alkyl group is more preferable. The number of carbon atoms of such an alkyl group is preferably 1 to 8, more preferably 1 to 6, and even more preferably 2 to 4, from the viewpoint of hydrophilicity and dynamic binding capacity when a ligand is immobilized.

Specific examples of the alkyl group include a methyl group, an ethyl group, an n-propyl group, an isopropyl group, an n-butyl group, an isobutyl group, a sec-butyl group, a tert-butyl group, a pentyl group, a hexyl group, a heptyl group, and an octyl group.

Further, examples of the hydrophilic group include a hydroxyl group, a carboxy group, an amino group, a sulfo group, a thiol group, a phosphate group, and an aldehyde group, and from the viewpoint of dynamic binding capacity when a ligand is immobilized and antifouling properties, a hydroxyl group is preferable.

Further, the substitution position of the hydrophilic group and the number of the hydrophilic groups are arbitrary, and the number thereof is preferably 1 to 6, more preferably 1 to 4, and particularly preferably 2, from the viewpoint of dynamic binding capacity when a ligand is immobilized and antifouling properties.

Further, in —(R⁶O)ₘ—H described above, the number of carbon atoms of the alkanediyl group represented by R⁶ is preferably 2 or 3 and more preferably 2. Further, such an alkanediyl group may be a linear chain or a branched chain. Specific examples thereof include an ethane-1,1-diyl group, an ethane-1,2-diyl group, a propane-1,1-diyl group, a propane-1,2-diyl group, a propane-1,3-diyl group, a propane-2,2-diyl group, a butane-1,2-diyl group, a butane-1,3-diyl group, and a butane-1,4-diyl group.

Further, m represents an integer of 1 to 50, and is preferably an integer of 1 to 30, more preferably an integer of 1 to 25, even more preferably an integer of 1 to 20, even more preferably an integer of 1 to 15, even more preferably an integer of 1 to 10, even more preferably an integer of 1 to 5, and particularly preferably an integer of 1 to 3, from the viewpoint of dynamic binding capacity when a ligand is immobilized, antifouling properties, and pressure resistance performance.

Among such R²s, a group in which at least one or more hydrogen atoms contained in the monovalent hydrocarbon group are substituted with a hydrophilic group is preferable, and preferred specific examples thereof include a monovalent organic group represented by the following Formula (3).

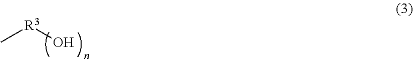

[In Formula (3),

R³ represents a divalent or trivalent organic group having 1 to 10 carbon atoms, and

n represents 1 or 2.]

The number of carbon atoms of the divalent or trivalent organic group represented by R³ in Formula (3) is preferably 1 to 8, more preferably 1 to 6, and even more preferably 2 to 4, from the viewpoint of dynamic binding capacity when a ligand is immobilized and antifouling properties.

Further, examples of the divalent organic group include a divalent hydrocarbon group, and the divalent organic group may be a linear chain or a branched chain. The divalent hydrocarbon group is preferably a divalent aliphatic hydrocarbon group and more preferably an alkanediyl group. The number of carbon atoms of such an alkanediyl group is preferably 1 to 8, more preferably 1 to 6, and even more preferably 2 to 4, from the viewpoint of dynamic binding capacity when a ligand is immobilized and antifouling properties.

Specific examples of the alkanediyl group include a methane-1,1-diyl group, an ethane-1,1-diyl group, an ethane-1,2-diyl group, a propane-1,1-diyl group, a propane-1,2-diyl group, a propane-1,3-diyl group, and a propane-2,2-diyl group.

Further, examples of the trivalent organic group include a trivalent hydrocarbon group and the trivalent organic group may be a linear chain or a branched chain. The trivalent hydrocarbon group is preferably a trivalent aliphatic hydrocarbon group and more preferably an alkanetriyl group. The number of carbon atoms of such an alkanetriyl group is preferably 1 to 8, more preferably 1 to 6, and even more preferably 2 to 4, from the viewpoint of dynamic binding capacity when a ligand is immobilized and antifouling properties.

Specific examples of the alkanetriyl group include a methane-1,1,1-triyl group, an ethane-1,1,2-triyl group, a propane-1,2,3-triyl group, and a propane-1,2,2-triyl group.

Further, from the viewpoint of dynamic binding capacity when a ligand is immobilized and antifouling properties, n in Formula (3) is preferably 2.

Further, from the viewpoint of dynamic binding capacity when a ligand is immobilized and the amount of the ligand which can be immobilized, the content of the functional group capable of fixing a ligand is preferably 0.05 to 6.5 mmol, more preferably 0.2 to 3.5 mmol, and particularly preferably 0.5 to 2 mmol per gram of the solid-phase carrier A.

The content of the functional group capable of fixing a ligand may be set in accordance with a quantitative determination method of each functional group, and for example, in the case of an epoxy group, the content thereof can be measured by, for example, ring-opening the epoxy group with an acid, neutralizing the ring-opened epoxy group with alkali, and then subjecting the neutralization product to a back-titration with an acid.

Further, from the viewpoint of dynamic binding capacity when a ligand is immobilized and antifouling properties, the content of a sulfinyl group, a sulfide group, an oxy group or an imino group is preferably 0.1 to 6.5 mmol, more preferably 0.5 to 4.5 mmol, and particularly preferably 1 to 3 mmol per gram of the solid-phase carrier A.

Further, when the solid-phase carrier A has a sulfinyl group, from the viewpoint of dynamic binding capacity when a ligand is immobilized and antifouling properties, the content of the sulfinyl group is preferably 0.1 to 6.5 mmol, more preferably 0.5 to 4.5 mmol, and particularly preferably 1 to 3 mmol per gram of the solid-phase carrier A.

Further, when the solid-phase carrier Ahas a sulfide group, from the viewpoint of dynamic binding capacity when a ligand is immobilized and antifouling properties, the content of the sulfide group is preferably 0.1 to 6.5 mmol, more preferably 0.5 to 4.5 mmol, and particularly preferably 1 to 3 mmol per gram of the solid-phase carrier A.

Further, when the solid-phase carrier A has a sulfinyl group and a sulfide group, a content ratio between the sulfinyl group and the sulfide group is preferably 100:0 to 30:70, more preferably 100:0 to 50:50, and particularly preferably 100:0 to 70:30 in terms of molar ratio.

Further, the solid-phase carrier A of the present invention preferably has the functional group capable of fixing a ligand on the surface thereof. Further, the solid-phase carrier A preferably has the group having a sulfinyl group, a sulfide group, an oxy group or an imino group, and a hydroxyl group, a thiol group, an amino group, a carboxy group, a sulfate group, a phosphate group or an alkanoyl group on the surface thereof.

Further, as the solid-phase carrier A of the present invention, a solid-phase carrier, which contains the functional group capable of fixing the ligand and a resin having the group having a sulfinyl group, a sulfide group, an oxy group or an imino group, and a hydroxyl group, a thiol group, an amino group, a carboxy group, a sulfate group, a phosphate group or an alkanoyl group, is preferable and a solid-phase carrier containing the resin on the surface thereof is more preferable.

Further, regarding a form of the solid-phase carrier A, any form such as a monolith, a film, a hollow fiber, a particle, a cassette, or a chip may be employed, and a particle form is preferable. Further, the solid-phase carrier A may be porous or non-porous, and from the viewpoint of improving a surface area, it is preferable to form the solid-phase carrier into a porous body such as porous particles. Further, as porous particles, porous polymer particles are preferable. Further, the resin is not particularly limited as long as it has the functional group capable of fixing the ligand, and the group having a sulfinyl group, a sulfide group, an oxy group or an imino group, and a hydroxyl group, a thiol group, an amino group, a carboxy group, a sulfate group, a phosphate group or an alkanoyl group, and the resin may be a natural polymer comprising polysaccharides such as agarose, dextran, and cellulose, or a synthetic polymer. As the resin, a resin having a structural unit derived from an ethylenically unsaturated monomer is preferable. Examples thereof include a resin having a structural unit derived from one or two or more monomers selected from the group consisting of a styrene-based monomer, a vinyl ketone-based monomer, a (meth)acrylonitrile-based monomer, a (meth)acrylate-based monomer, and a (meth)acrylamide-based monomer.

Further, when the solid-phase carrier A of the present invention is formed of a polymer, the polymer may have a terminal structure having at least one selected from the group consisting of a hydroxyl group, a thiol group, a carbonyl group, an amino group, a thio group, a disulfide group, a sulfinyl group, a sulfonyl group, a carboxy group, a sulfate group, and a phosphate group, in the terminal of the chain through a thio group, a sulfinyl group or a sulfonyl group. Such a polymer and the terminal structure thereof are the same as those of the carrier D for affinity refining.

Further, when the solid-phase carrier A of the present invention is particles, from the view point of pressure resistance performance, the average particle diameter (volume average particle diameter) thereof is preferably 20 to 150 m and more preferably 40 to 100 μm. Further, the variation coefficient of the average particle diameter is preferably 40% or less and more preferably 30% or less.

Further, from the viewpoint of dynamic binding capacity when a ligand is immobilized, the specific surface area of the solid-phase carrier A of the present invention is preferably 70 m²/g or more and more preferably 90 m²/g or more with respect to the specific surface area in a pore size of 10 nm to 5000 nm.

Further, from the viewpoint of dynamic binding capacity when a ligand is immobilized, the specific surface area of the solid-phase carrier A of the present invention is preferably 70 m²/g or more and more preferably 90 m²/g or more with respect to the specific surface area in a pore size of 10 nm to 5000 nm.

The average particle diameter and the specific surface area may be measured by, for example, a laser diffraction/scattering particle size analysis measurement apparatus or a mercury porosimeter.

Next, the method for producing the solid-phase carrier A of the present invention will be described in detail.

The method for producing the solid-phase carrier A of the present invention is not particularly limited as long as the solid-phase carrier A is produced by appropriately combining normal methods, and for example, the solid-phase carrier A can be obtained by the following methods [PR-1] and [PR-2]. According to the methods [PR-1] and [PR-2], it is possible to easily obtain the solid-phase carrier A having excellent antifouling properties and exhibiting high dynamic binding capacity when a ligand is immobilized.

[PR-1] A method of bringing a solid-phase carrier having a functional group capable of fixing a ligand (hereinafter, also referred to as the raw material carrier (I)) into contact with a compound represented by Formula (4). Specifically, a method, which includes <Step 1-1> obtaining the raw material carrier (I) in accordance with a normal method and <Step 1-2> bringing the raw material carrier (I) into contact with the compound represented by Formula (4), is exemplified.

According to such a method [PR-1], it is possible to obtain a solid-phase carrier having a functional group capable of fixing a ligand and a group represented by Formula (5-1), (5-2) or (5-3).

[PR-2] A method of bringing the raw material carrier (I) into contact with the compound represented by Formula (4) in which Y is a sulfide group to obtain a solid-phase carrier having a functional group capable of fixing a ligand and a group represented by Formula (5-1), (5-2) or (5-3) in which Y is a sulfide group (hereinafter, also referred to as the sulfide group-containing solid-phase carrier (II)) and then bringing the sulfide group-containing solid-phase carrier (II) into contact with an oxidant.

Specifically, a method which includes <Step 2-1> obtaining the raw material carrier (I) in accordance with a normal method, <Step 2-2> bringing the raw material carrier (I) into contact with the compound represented by Formula (4) in which Y is a sulfide group to obtain the sulfide group-containing solid-phase carrier (II), and <Step 2-3> bringing the sulfide group-containing solid-phase carrier (II) into contact with an oxidant.

According to such a method [PR-2], it is possible to obtain a solid-phase carrier having a functional group capable of fixing a ligand and a group represented by Formula (6-1), (6-2) or (6-3).

R²—Y—H (4)

[In Formula (4),

Y represents a sulfide group, an oxy group or an imino group, and

R² has the same meaning as defined above and represents a monovalent organic group having 1 to 10 carbon atoms.]

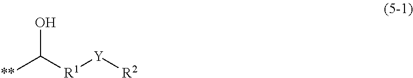

[In Formula (5-1),

R¹ has the same meaning as defined above and represents a divalent hydrocarbon group having 1 to 6 carbon atoms,

R² has the same meaning as defined above and represents a monovalent organic group having 1 to 10 carbon atoms,

Y has the same meaning as defined above and represents a sulfide group, an oxy group or an imino group, and

** represents a bond.]

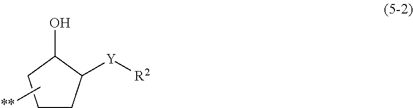

[In Formula (5-2), R², Y, and ** have the same meaning as defined above.]

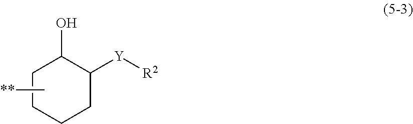

[In Formula (5-3), R², Y, and ** have the same meaning as defined above.]

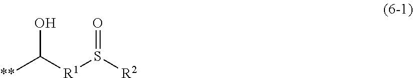

[In Formula (6-1), R¹, R², and ** have the same meaning as defined above.]

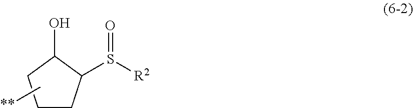

[In Formula (6-2), R² and ** have the same meaning as defined above.]

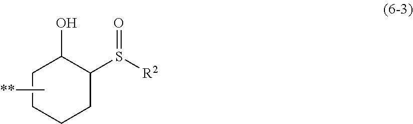

[In Formula (6-3), R² and ** have the same meaning as defined above.]

Hereinafter, each step described above will be described in detail.

<Steps 1-1 and 2-1>

Steps 1-1 and 2-1 are steps of obtaining the raw material carrier (I). For example, a monomer having a functional group capable of fixing a ligand may be (co)polymerized. Examples of the (co)polymerization method include seed polymerization and suspension polymerization, and suspension polymerization is preferable.

Here, examples of the functional group capable of fixing a ligand contained in the raw material carrier (I) include a cyclic ether group, a carboxy group, a succinimidoxy group, a formyl group, an isocyanate group, and an amino group. Among these, a cyclic ether group is preferable, a cyclic ether group having 3 to 7 atoms that form a ring is more preferable, a group represented by the following Formula (1-1), (1-2) or (1-3) is even more preferable, and a group represented by the following Formula (1-1) is particularly preferable.

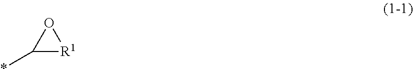

[In Formula (1-1),

R¹ represents a divalent hydrocarbon group having 1 to 6 carbon atoms, and

* represents a bond.]

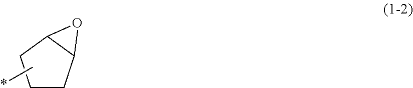

[In Formula (1-2), *has the same meaning as defined above.]

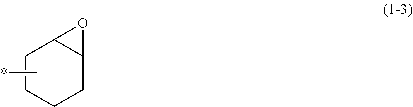

[In Formula (1-3), * has the same meaning as defined above.]

In Formula (1-1), R¹ represents a divalent hydrocarbon group having 1 to 6 carbon atoms. The number of carbon atoms of such a divalent hydrocarbon group is preferably 1 to 4, more preferably 1 or 2, and particularly preferably 1. Further, the divalent hydrocarbon group may be a linear chain or a branched chain.

Further, the divalent hydrocarbon group is preferably a divalent aliphatic hydrocarbon group and more preferably an alkanediyl group. Preferred specific examples thereof include a methane-1,1-diyl group, an ethane-1,1-diyl group, and an ethane-1,2-diyl group.

A monomer having a group represented by Formula (1-1) is preferable as a monomer having a functional group capable of fixing a ligand and examples thereof include an epoxy group-containing unsaturated monomer. As such an epoxy group-containing unsaturated monomer, a (meth)acrylate-based monomer or a styrene-based monomer is preferable, a (meth)acrylate-based monomer is more preferable, and a (meth)acrylate-based monomer represented by the following Formula (7) is particularly preferable.

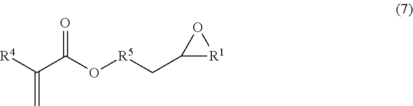

[In Formula (7),

R⁴ represents a hydrogen atom or a methyl group,

R⁵ represents a single bond, a divalent hydrocarbon group having 1 to 10 carbon atoms or —(R^{b}O)ₘ— (R^{b} represents an alkanediyl group having 2 to 4 carbon atoms and m represents an integer of 1 to 50), and

R¹ has the same meaning as defined above and represents a divalent hydrocarbon group having 1 to 6 carbon atoms.]

The number of carbon atoms of the divalent hydrocarbon group represented by R⁵ is preferably 1 to 8, more preferably 1 to 6, and even more preferably 1 to 4. The divalent hydrocarbon group may be a linear chain or a branched chain.

Further, the divalent hydrocarbon group is preferably a divalent aliphatic hydrocarbon group and more preferably an alkanediyl group. The number of carbon atoms of such an alkanediyl group is preferably 1 to 8, more preferably 1 to 6, and even more preferably 1 to 4.

Specific examples of the alkanediyl group include a methane-1,1-diyl group, an ethane-1,1-diyl group, an ethane-1,2-diyl group, a propane-1,1-diyl group, a propane-1,2-diyl group, a propane-1,3-diyl group, and a propane-2,2-diyl group.

The number of carbon atoms of the alkanediyl group represented by R⁶ is preferably 2 or 3 and more preferably 2. Further, such an alkanediyl group may be a linear chain or a branched chain. Specific examples thereof include an ethane-1,1-diyl group, an ethane-1,2-diyl group, a propane-1,1-diyl group, a propane-1,2-diyl group, a propane-1,3-diyl group, a propane-2,2-diyl group, a butane-1,2-diyl group, a butane-1,3-diyl group, and a butane-1,4-diyl group.

Further, m represents an integer of 1 to 50, and is preferably an integer of 1 to 30, more preferably an integer of 1 to 25, even more preferably an integer of 1 to 20, even more preferably an integer of 1 to 15, even more preferably an integer of 1 to 10, even more preferably an integer of 1 to 5, and particularly preferably an integer of 1 to 3.

Further, among R⁵s as described above, a single bond is preferable.

Further, as the monomer having a functional group capable of fixing the ligand, glycidyl(meth)acrylate, 4-hydroxybutyl(meth)acrylate glycidyl ether, α-(meth)acryl-ω-glycidyl polyethylene glycol, (4-vinylbenzyl)glycidyl ether, (7-oxabicyclo[4.1.0]heptan-3-yl)methyl(meta)acrylate, allyl glycidyl ether, 3,4-epoxy-1-butene, or 3,4-epoxy-3-methyl-1-butene is exemplified, and these can be used alone or in combination of two or more thereof.

Further, from the viewpoint of dynamic binding capacity when a ligand is immobilized and an amount of a ligand which can be immobilized, the total used amount of the monomer having a functional group capable of fixing the ligand is preferably 1 to 90 parts by mass, more preferably 20 to 80 parts by mass, and particularly preferably 30 to 70 parts by mass, with respect to 100 parts by mass of the total amount of the monomer.

Further, in Steps 1-1 and 2-1, other monomers may be used with the monomer having a functional group capable of fixing a ligand. As the other monomers, any of a non-crosslinkable monomer and a crosslinkable monomer can be used and these may be used in combination.

Examples of the non-crosslinkable monomer include a hydroxyl group-containing non-crosslinkable unsaturated monomer and a non-crosslinkable unsaturated monomer not containing a hydroxyl group. Examples of the crosslinkable monomer include a hydroxyl group-containing crosslinkable unsaturated monomer and a crosslinkable unsaturated monomer not containing a hydroxyl group.

As the hydroxyl group-containing non-crosslinkable unsaturated monomer, a (meth)acrylate-based monomer and a (meth)acrylamide-based monomer are preferable, and a (meth)acrylate-based monomer is more preferable. Of them, a (meth)acrylate-based monomer represented by the following Formula (8) is particularly preferable. The number of hydroxyl groups contained in the hydroxyl group-containing non-crosslinkable unsaturated monomer is preferably 1 to 5 and more preferably 1 to 3.

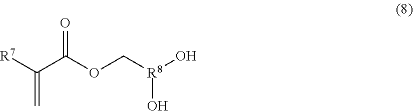

[In Formula (8),

R⁷ represents a hydrogen atom or a methyl group, and

R⁸ represents a trivalent hydrocarbon group having 1 to 6 carbon atoms.]

The trivalent hydrocarbon group represented by R⁸ may be a linear chain or a branched chain. Further, the number of carbon atoms thereof is preferably 2 to 4.

Further, the trivalent hydrocarbon group is preferably a trivalent aliphatic hydrocarbon group and more preferably an alkanetriyl group. Specific examples thereof include an ethane-1,1,2-triyl group.

Examples of the hydroxyl group-containing non-crosslinkable unsaturated monomer include glycerol mono(meth)acrylate, trimethylolethane mono(meth)acrylate, trimethylolpropane mono(meth)acrylate, butanetriol mono(meth)acrylate, polyethylene glycol mono(meth)acrylate, pentaerythritol mono(meth)acrylate, dipentaerythritol mono(meth)acrylate, inositol mono(meth)acrylate, hydroxyethyl(meth)acrylate, hydroxypropyl(meth)acrylate, and hydroxyethyl(meth)acrylamide, and these can be used alone or in combination of two or more thereof.

Further, from the viewpoint of dynamic binding capacity and antifouling properties, the total used amount of the hydroxyl group-containing non-crosslinkable unsaturated monomer is preferably 0 to 70 parts by mass, more preferably 3 to 50 parts by mass, and particularly preferably 5 to 20 parts by mass, with respect to 100 parts by weight of the total amount of the monomer.

Further, as the non-crosslinkable unsaturated monomer not containing a hydroxyl group, a (meth)acrylate-based monomer and a (meth)acrylamide-based monomer are preferable, and a (meth)acrylate-based monomer is more preferable. Of them, a (meth)acrylate-based monomer represented by the following Formula (9) is particularly preferable.

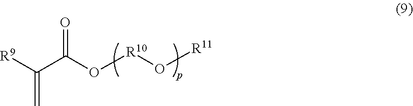

[In Formula (9),

R⁹ represents a hydrogen atom or a methyl group,

R¹⁰ represents an alkanediyl group having 2 to 4 carbon atoms,

R¹¹ represents a monovalent hydrocarbon group having 1 to 6 carbon atoms, and

p represents an integer of 0 to 50.]

The number of carbon atoms of the alkanediyl group represented by R¹⁰ is preferably 2 or 3 and more preferably 2. Further, such an alkanediyl group may be a linear chain or a branched chain. Specific examples thereof include an ethane-1,1-diyl group, an ethane-1,2-diyl group, a propane-1,1-diyl group, a propane-1,2-diyl group, a propane-1,3-diyl group, a propane-2,2-diyl group, a butane-1,2-diyl group, a butane-1,3-diyl group, and a butane-1,4-diyl group.

The number of carbon atoms of the monovalent hydrocarbon group represented by R¹¹ is preferably 1 to 4 and more preferably 1 or 2.

The monovalent hydrocarbon group encompasses the concept including a monovalent aliphatic hydrocarbon group, a monovalent alicyclic hydrocarbon group, and a monovalent aromatic hydrocarbon group, and a monovalent aliphatic hydrocarbon group is preferable. The monovalent aliphatic hydrocarbon group may be a linear chain or a branched chain.

An alkyl group is preferable as the monovalent aliphatic hydrocarbon group, and the number of carbon atoms of such an alkyl group is preferably 1 to 4 and more preferably 1 or 2.

Specific examples of the alkyl group include a methyl group, an ethyl group, an n-propyl group, an isopropyl group, an n-butyl group, an isobutyl group, a sec-butyl group, a tert-butyl group, a pentyl group, and a hexyl group.

p represents an integer of 0 to 50, and is preferably an integer of 1 to 25 and more preferably an integer of 1 to 15.

Examples of the non-crosslinkable unsaturated monomer not containing a hydroxyl group include methoxypolyethylene glycol(meth)acrylate, methyl(meth)acrylate, ethyl(meth)acrylate, butyl(meth)acrylate, cyclohexyl(meth)acrylate, methoxyethyl(meth)acrylate, (meth)acrylamide, dimethyl(meth)acrylamide, (meth)acryloylmorpholine, and diacetone(meth)acrylamide, and these can be used alone or in combination of two or more thereof.

Further, from the viewpoint of dynamic binding capacity and antifouling properties, the total used amount of the non-crosslinkable unsaturated monomer not containing a hydroxyl group is preferably 0 to 70 parts by mass, more preferably 3 to 50 parts by mass, and particularly preferably 5 to 30 parts by mass, with respect to 100 parts by mass of the total amount of the monomer.

Further, as the hydroxyl group-containing crosslinkable unsaturated monomer, those having a functionality of 2 to 5 are preferable and those having a functionality of 2 or 3 are more preferable. Further, the number of hydroxyl groups contained in the hydroxyl group-containing crosslinkable unsaturated monomer is preferably 1 to 5 and more preferably 1 to 3, from the viewpoint of dynamic binding capacity and antifouling properties.

Further, a (meth)acrylate-based monomer is preferable as the hydroxyl group-containing crosslinkable unsaturated monomer. In particular, a (meth)acrylate-based monomer represented by the following Formula (10) is particularly preferable.

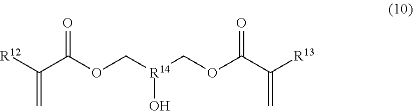

[In Formula (10),

R¹² and R¹³ each independently represent a hydrogen atom or a methyl group, and

R¹⁴ represents a trivalent hydrocarbon group having 1 to 8 carbon atoms.]

The trivalent hydrocarbon group represented by R¹⁴ may be a linear chain or a branched chain. Further, the number of carbon atoms thereof is preferably 1 to 5.

Further, the trivalent hydrocarbon group is preferably a trivalent aliphatic hydrocarbon group and more preferably an alkanetriyl group. Specific examples thereof include a methane-1,1,1-triyl group.

Examples of the hydroxyl group-containing crosslinkable unsaturated monomer include glycerin di(meth)acrylate, trimethylolethane di(meth)acrylate, trimethylolpropane di(meth)acrylate, butanetriol di(meth)acrylate, pentaerythritol di(meth)acrylate, pentaerythritol tri(meth)acrylate, dipentaerythritol di(meth)acrylate, dipentaerythritol tri(meth)acrylate, dipentaerythritol tetra(meth)acrylate, dipentaerythritol penta(meth)acrylate, inositol di(meth)acrylate, inositol tri(meth)acrylate, and inositol tetra(meth)acrylate, and there can be used alone or in combination of two or more thereof.

When the hydroxyl group-containing crosslinkable unsaturated monomer is used, from the viewpoint of dynamic binding capacity and antifouling properties, the total used amount thereof is preferably 0 to 70 parts by mass, more preferably 3 to 50 parts by mass, and preferably 5 to 20 parts by mass, with respect to 100 parts by mass of the total amount of the monomer.

Further, as the crosslinkable unsaturated monomer not containing a hydroxyl group, those having a functionality of 2 to 5 are preferable and those having a functionality of 2 or 3 are more preferable.

Further, a (meth)acrylate-based monomer is preferable as the crosslinkable unsaturated monomer not containing a hydroxyl group. In particular, a (meth)acrylate-based monomer represented by the following Formula (11) or (12) is particularly preferable.

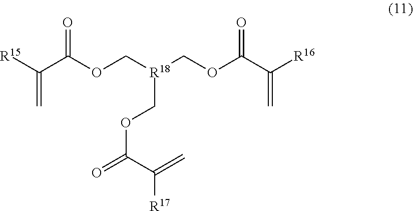

[In Formula (11),

R¹⁵ to R¹⁷ each independently represent a hydrogen atom or a methyl group, and

R¹⁸ represents a trivalent hydrocarbon group having 1 to 6 carbon atoms.]

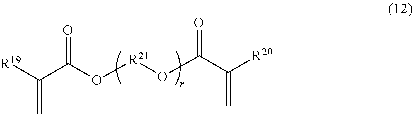

[In Formula (12),

R¹⁹ and R²⁰ each independently represent a hydrogen atom or a methyl group,

R²¹ represents an alkanediyl group having 2 to 4 carbon atoms, and

r represents an integer of 1 to 50.]

The trivalent hydrocarbon group represented by R¹⁸ in Formula (11) may be a linear chain or a branched chain. Further, the number of carbon atoms thereof is preferably 2 to 4.

Further, the trivalent hydrocarbon group is preferably a trivalent aliphatic hydrocarbon group and more preferably an alkanetriyl group. Specific examples thereof include a propane-1,1,1-triyl group.

Further, the number of carbon atoms of the alkanediyl group represented by R²¹ in Formula (12) is preferably 2 or 3 and more preferably 2. Further, such an alkanediyl group may be a linear chain or a branched chain. Specific examples thereof include an ethane-1,1-diyl group, an ethane-1,2-diyl group, a propane-1,1-diyl group, a propane-1,2-diyl group, a propane-1,3-diyl group, a propane-2,2-diyl group, a butane-1,2-diyl group, a butane-1,3-diyl group, and a butane-1,4-diyl group.

Further, r represents an integer of 1 to 50, and is preferably an integer of 1 to 30, more preferably an integer of 1 to 25, even more preferably an integer of 1 to 20, even more preferably an integer of to 15, and particularly preferably an integer of 1 to 10.

Examples of the crosslinkable unsaturated monomer not containing a hydroxyl group include trimethylolpropane tri(meth)acrylate, (poly)ethylene glycol di(meth)acrylate, (poly)propylene glycol di(meth)acrylate, 1,4-butanediol di(meth)acrylate, 1,6-hexanediol di(meth)acrylate, and pentaerythritol tetra(meth)acrylate, and these can be used alone or in combination of two or more thereof.

Further, from the viewpoint of dynamic binding capacity and antifouling properties, the total used amount of the crosslinkable unsaturated monomer not containing a hydroxyl group is preferably 1 to 90 parts by mass, more preferably 5 to 70 parts by mass, even more preferably 10 to 60 parts by mass, and particularly preferably 20 to 50 parts by mass, with respect to 100 parts by mass of the total amount of the monomer.

From the viewpoint of dynamic binding capacity when a ligand is immobilized and antifouling properties, as a combination of a monomer having a functional group capable of fixing a ligand and another monomer, a combination including a monomer having a functional group capable of fixing a ligand and at least a hydroxyl group-containing non-crosslinkable unsaturated monomer and a crosslinkable unsaturated monomer not containing a hydroxyl group is preferable, a combination of a monomer having a functional group capable of fixing a ligand, a hydroxyl group-containing non-crosslinkable unsaturated monomer, and a crosslinkable unsaturated monomer not containing a hydroxyl group and a combination of a monomer having a functional group capable of fixing a ligand, a hydroxyl group-containing non-crosslinkable unsaturated monomer, a non-crosslinkable unsaturated monomer not containing a hydroxyl group, and a crosslinkable unsaturated monomer not containing a hydroxyl group are more preferable, and a combination of a monomer having a functional group capable of fixing a ligand, a hydroxyl group-containing non-crosslinkable unsaturated monomer, and a crosslinkable unsaturated monomer not containing a hydroxyl group is particularly preferable.

Further, examples of the specific method of Steps 1-1 and 2-1 include a method of dissolving a polymerization initiator in a mixed solution containing a monomer and, as necessary, a pore-forming agent (monomer solution), suspending the resultant solution in an aqueous medium, and polymerizing the suspended solution by heating to a predetermined temperature, a method of dissolving a polymerization initiator in a mixed solution containing a monomer and, as necessary, a pore-forming agent (monomer solution), adding the resultant solution to an aqueous medium which has been heated to a predetermined temperature, and polymerizing the resultant mixture, and a method of suspending a mixed solution containing a monomer and, as necessary, a pore-forming agent (monomer solution) in an aqueous medium, heating the suspended solution to a predetermined temperature, and polymerizing the resultant solution by adding a polymerization initiator.

As the polymerization initiator, radical polymerization initiators are preferable. Examples of the radical polymerization initiators include azo-based initiators, peroxide-based initiators, and redox-based initiator, and specific examples thereof include azobisisobutyronitrile, methyl azobisisobutyrate, azobis-2,4-dimethyl valeronitrile, benzoyl peroxide, di-tert-butyl peroxide, and benzoyl peroxide-dimethylaniline. The total used amount of the polymerization initiator is generally about 0.01 to 10 parts by mass with respect to 100 parts by mass of the total amount of the monomer.

The pore-forming agent is used for producing porous particles, is present with the monomers in polymerization in oil droplets, and has a role in forming pores as a non-polymerizable component. The pore-forming agent is not particularly limited as long as it can be easily removed on the porous surface, and examples thereof include linear polymers which are soluble in various organic solvents and a mixed monomer. These may be used in combination.

Examples of the pore-forming agent include aliphatic hydrocarbons such as hexane, heptane, octane, nonane, decane, and undecane; alicyclic hydrocarbons such as cyclohexane and cyclopentane; aromatic hydrocarbons such as benzene, toluene, xylene, naphthalene, and ethylbenzene; halogenated hydrocarbons such as carbon tetrachloride, 1,2-dichloroethane, tetrachloroethane, and chlorobenzene; aliphatic alcohols such as butanol, pentanol, hexanol, heptanol, hexanol, 4-methyl-2-pentanol, and 2-ethyl-1-hexanol; alicyclicalcohols such as cyclohexanol; aromatic alcohols such as 2-phenylethyl alcohol and benzyl alcohol; ketones such as diethyl ketone, methyl isobutyl ketone, diisobutyl ketone, acetophenone, 2-octanone, and cyclohexanone; ethers such as dibutyl ether, diisobutyl ether, anisole, and ethoxybenzene; and esters such as isopentyl acetate, butyl acetate, 3-methoxybutyl acetate, and diethyl malonate, as well as linear polymers such as homopolymers of non-crosslinkable vinyl monomers. These pore-forming agents can be used alone or in combination of two or more thereof.

The total used amount of the pore-forming agent is generally about 40 to 400 parts by mass with respect to 100 parts by mass of the total amount of the monomer.

Examples of the aqueous medium include aqueous solutions of water-soluble polymers, and examples of the water-soluble polymers include hydroxyethyl cellulose, polyvinyl alcohol, carboxymethyl cellulose, polyvinylpyrrolidone, starch, and gelatin.

The total used amount of the aqueous medium is generally about 200 to 7000 parts by mass with respect to 100 parts by mass of the total amount of the monomer.

Further, when water is used as the dispersion medium of the aqueous medium, for example, a dispersion stabilizer such as sodium chloride, sodium sulfate, sodium carbonate, calcium carbonate, or calcium phosphate may be used.

Further, in Steps 1-1 and 2-1, various surfactants including anionic surfactants such as alkyl sulfate salts, alkylaryl sulfate salts, alkyl phosphate salts, and fatty acid salts may be used.

Further, a polymerization inhibitor such as a nitrite salt (for example, sodium nitrite), an iodide salt (for example, potassium iodide), tert-butylpyrocatechol, benzoquinone, picric acid, hydroquinone, copper chloride, or ferric chloride can also be used.

Further, a polymerization regulator such as dodecyl mercaptan may be used.

Further, the polymerization temperature in Steps 1-1 and 2-1 may depends on a polymerization initiator, and for example, when azobisisobutyronitrile is used as a polymerization initiator, the polymerization temperature is preferably 50 to 100° C. and more preferably 60 to 90° C.

Further, the polymerization time is generally 5 minutes to 48 hours and preferably 10 minutes to 24 hours.

### <Steps 1-2 and 2-2>

Step 1-2 is a step of obtaining a solid-phase carrier having a functional group capable of fixing a ligand and a group represented by the following Formula (5-1), (5-2) or (5-3) by bringing the raw material carrier (I) into contact with a compound represented by the following Formula (4).

Further, Step 2-2 is a step of obtaining the sulfide group-containing solid-phase carrier (II) by bringing the raw material carrier (I) into contact with the compound represented by the following Formula (4) in which Y is a sulfide group.

R²—Y—H (4)

[In Formula (4),

Y represents a sulfide group, an oxy group or an imino group, and

R² has the same meaning as defined above and represents a monovalent organic group having 1 to 10 carbon atoms.]

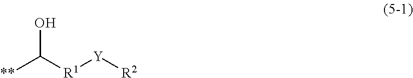

[In Formula (5-1),

R¹ has the same meaning as defined above and represents a divalent hydrocarbon group having 1 to 6 carbon atoms,

R² has the same meaning as defined above and represents a monovalent organic group having 1 to 10 carbon atoms,

Y has the same meaning as defined above and represents a sulfide group, an oxy group or an imino group, and

** represents a bond.]

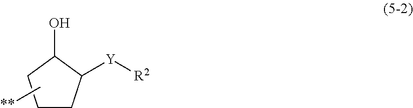

[In Formula (5-2), R², Y, and ** have the same meaning as defined above.]

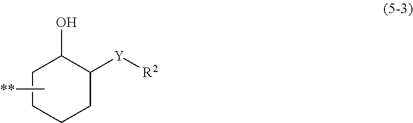

[In Formula (5-3), R², Y, and ** have the same meaning as defined above.]

Examples of the compound (4) used in Steps 1-2 and 2-2 include thioglycerol, mercaptoethanol, and monoethanolamine, and thioglycerol is preferable.

The total used amount of the compound (4) is generally 0.1 to 12 molar equivalent, preferably 1 to 10 molar equivalent, and more preferably 2 to 8 molar equivalent per mole of the functional group capable of fixing a ligand.

Steps 1-2 and 2-2 may be performed in the presence of a basic catalyst. Examples of such a basic catalyst include triethylamine, N,N-dimethyl-4-aminopyridine, and diisopropylethylamine, and these can be used alone or in combination of two or more thereof.

Further, the reaction time of Steps 1-2 and 2-2 is not particularly limited, and is generally about 0.5 to 72 hours and preferably 1 to 48 hours. Further, the reaction temperature may be appropriately selected from a temperature equal to or lower than a boiling point of the solvent, and is generally about 2 to 100° C.

### <Step 2-3>

Step 2-3 is a step of obtaining a solid-phase carrier having a functional group capable of fixing a ligand and a group represented by the following Formula (6-1), (6-2) or (6-3) by bringing the sulfide group-containing solid-phase carrier (II) obtained in Step 2-2 into contact with an oxidant to oxidize a sulfide group to a sulfinyl group.

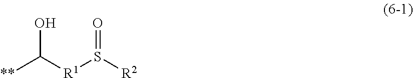

[In Formula (6-1), R¹, R², and ** have the same meaning as defined above.]

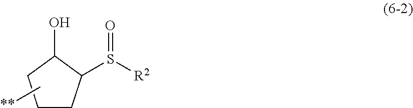

[In Formula (6-2), R² and** have the same meaning as defined above.]

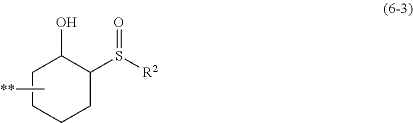

[In Formula (6-3), R² and ** have the same meaning as defined above.]

The oxidant to be used in Step 2-3 is roughly divided into an organic oxidant and an inorganic oxidant, and examples of the organic oxidant include peracetic acid, perbenzoic acid, and m-chloroperbenzoic acid. Meanwhile, examples of the inorganic oxidant include hydrogen peroxide, chromic acid, and permanganate. These oxidants can be used alone or in combination of two or more thereof.

Further, the total used amount of the oxidant is generally about 0.1 to 10 molar equivalent and preferably 0.5 to 3 molar equivalent per mole of the sulfide group.

Further, Step 2-3 is preferably performed in the presence of a solvent. Examples of such a solvent include water; amide-based solvents such as dimethylformamide and dimethylacetamide; and alcohol-based solvents such as methanol and ethanol, and these can be used alone or in combination of two or more thereof.

The total used amount of the solvent is generally about 1 to 50 times by mass and preferably 5 to 15 times by mass with respect to the solid-phase carrier as a raw material.

Further, the reaction time of Step 2-3 is not particularly limited, and is generally about 1 to 72 hours, and the reaction temperature may be appropriately selected from a temperature equal to or lower than a boiling point of the solvent, and is generally about 1 to 90° C.

The solid-phase carrier to be obtained by each step described above can be obtained by removing the pore-forming agent and the unreacted monomer by, for example, distillation, extraction or washing, as necessary.

Further, the solid-phase carrier A of the present invention to be obtained as described above exhibits high dynamic binding capacity when a ligand is immobilized, has excellent antifouling properties, and is unlikely to have non-specific adsorption of impurities such as a host cell protein (HCP).

The solid-phase carrier A of the present invention is useful as a solid-phase carrier to be used for a filler for affinity chromatography, a flow passage, or a sensor chip or the like.

### <Production Method C of Filler for Affinity Chromatography>

The production method C of the filler for affinity chromatography of the present invention is characterized by including a step of fixing a ligand to the solid-phase carrier A of the present invention or a solid-phase carrier obtained by the production method B of the present invention.

The ligand may be a molecule to be bound to a target substance, and examples thereof include proteins such as Protein A, Protein G, Protein L, Fc binding protein, and avidin; peptides such as insulin; antibodies such as monoclonal antibodies; enzymes; hormones; DNA; RNA; carbohydrates such as heparin, Lewis X, and gangliosides; and low-molecular-weight compounds such as iminodiacetic acid, synthetic dyes, 2-aminophenylboronic acid, 4-aminobenzamidine, glutathione, biotin, and derivative thereof. The above-exemplified ligands may be used as a whole molecule, or the fragments thereof obtainable by, for example, recombination or enzyme treatment may also be used. Further, artificially synthesized peptides or peptide derivatives may also be used.

Among these ligands, when a refined target substance is an antibody, those containing an amino group are preferable, proteins and peptides are more preferable, proteins are even more preferable, and an immunoglobulin-binding protein is even more preferable. As the immunoglobulin-binding protein, at least one or more selected from the group consisting of Protein A, Protein G, Protein L, Fc binding protein, and functional mutants thereof are preferable. Among these, Protein A, Protein G, and functional mutants thereof are preferable, and Protein A and functional mutants thereof are more preferable.

Further, the total used amount of the ligand is generally about 50 to 300 mg per gram of the solid-phase carrier A, and is preferably 120 to 180 mg.

The fixation of a ligand may be performed in the same manner as in a normal method, except that the solid-phase carrier A is used, and is preferably performed in a buffer solution with a salt added.

Examples of the type of the salt include trisodium citrate and sodium sulfate, and examples of the buffer solution include a sodium phosphate buffer solution, a potassium phosphate buffer solution, and a boric acid buffer solution.

The total used amount of the buffer solution is generally about 20 to 80 times by mass and preferably 35 to 45 times by mass with respect to the solid-phase carrier A.

Further, the reaction time is not particularly limited, and is generally about 0.5 to 72 hours and the reaction temperature is generally about 1 to 40° C.

Further, in the production method C of the filler of the present invention, after the fixation step, the obtained filler for affinity chromatography may be brought into contact with the compound represented by Formula (4) and the unreacted functional group capable of fixing a ligand may be allowed to react. Further, the filler for affinity chromatography may be brought into contact with an oxidant after the reaction.

According to this, the functional group to which a ligand is not bound is converted to a group represented by Formula (2-1), (2-2) or (2-3).

Further, according to the production method C of the filler of the present invention, it is possible to simply and easily produce a filler for affinity chromatography having high dynamic binding capacity and excellent antifouling properties.

<Carrier D for Affinity Refining>

The carrier D for affinity refining of the present invention is a carrier for affinity refining which has a solid-phase carrier and a ligand or a reactive group for binding a ligand, characterized in that the ligand or the reactive group for binding a ligand is bound to the solid-phase carrier, and a polymer constituting the solid-phase carrier has a terminal structure having at least one group selected from the group consisting of a hydroxyl group, a thiol group, a carbonyl group, an amino group, a thio group, adisulfide group, a sulfinyl group, a sulfonyl group, a carboxy group, a sulfate group, and a phosphate group, in the terminal of the chain, through a thio group, a sulfinyl group or a sulfonyl group.

As a thio group, a sulfinyl group or a sulfonyl group for connecting the terminal structure, a thio group or a sulfonyl group is preferable.

(Terminal Structure)

The terminal structure is positioned at the terminal of the polymer chain through a thio group, a sulfinyl group or a sulfonyl group. As the terminal structure, a terminal structure represented by the following Formula (21) is preferable.

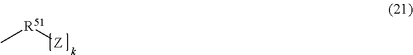

[In Formula (21),

R⁵¹ represents an organic group having 1 to 20 carbon atoms,

Z represents a hydroxyl group, a thiol group, an amino group, a carboxy group, a sulfate group, a phosphate group or an alkanoyl group, and

k represents an integer of 1 or more.]

Herein, k in Formula (21) represents an integer of 1 or more, and is preferably an integer of 1 to 5, more preferably an integer of 1 to 3, and particularly preferably an integer of 1 or 2. That is, the valence of the organic group represented by R⁵¹ is preferably di- to hexavalent, more preferably di- to tetravalent, and particularly preferably di- or trivalent.

The number of carbon atoms of the organic group having 1 to 20 carbon atoms represented by R⁵¹ in Formula (21) is preferably 1 to 8, more preferably 1 to 6, and even more preferably 2 to 4, from the viewpoint of dynamic binding capacity when a ligand is bound and antifouling properties.

Further, a hydrocarbon group is preferable as the organic group represented by R⁵¹. The hydrocarbon group may be a linear chain or a branched chain, and is preferably an aliphatic hydrocarbon group and more preferably a di- or trivalent aliphatic hydrocarbon group.

An alkanediyl group is preferable as the divalent aliphatic hydrocarbon group. The number of carbon atoms of such an alkanediyl group is preferably 1 to 8, more preferably 1 to 6, and even more preferably 2 to 4, from the viewpoint of dynamic binding capacity when a ligand is bound and antifouling properties. Specific examples of the alkanediyl group include a methane-1,1-diyl group, an ethane-1,1-diyl group, an ethane-1,2-diyl group, a propane-1,1-diyl group, a propane-1,2-diyl group, a propane-1,3-diyl group, and a propane-2,2-diyl group.

An alkanetriyl group is preferable as the trivalent aliphatic hydrocarbon group. The number of carbon atoms of such an alkanetriyl group is preferably 1 to 8, more preferably 1 to 6, and even more preferably 2 to 4, from the viewpoint of dynamic binding capacity when a ligand is bound and antifouling properties. Specific examples of the alkanetriyl group include a methane-1,1,1-triyl group, an ethane-1,1,2-triyl group, a propane-1,2,3-triyl group, and a propane-1,2,2-triyl group.

Z in Formula (21) represents a hydroxyl group, a thiol group, an amino group, a carboxy group, a sulfate group, a phosphate group or an alkanoyl group. The alkanoyl group may be a linear chain or a branched chain, and the number of carbon atoms thereof is preferably 2 to 10, more preferably 2 to 6, and particularly preferably 2 to 4. Examples of the alkanoyl group include an acetyl group, a propionyl group, a butyryl group, and a valeryl group.

As Z, from the viewpoint of dynamic binding capacity when a ligand is bound and antifouling properties, a hydroxyl group, a thiol group, a carboxy group, a sulfate group, and an alkanoyl group are preferable, and a hydroxyl group, a carboxy group, and a sulfate group are more preferable. Among these, a hydroxyl group is particularly preferable.

### (Ligand or the Like)

Further, the carrier D for affinity refining of the present invention has a ligand or a reactive group for binding a ligand. The ligand may be a molecule to be bound to a target substance, and examples thereof include proteins such as Protein A, Protein G, Protein L, Fc binding protein, and avidin; peptides such as insulin; antibodies such as monoclonal antibodies; enzymes; hormones; DNA; RNA; carbohydrates such as heparin, Lewis X, and gangliosides; and low-molecular-weight compounds such as iminodiacetic acid, synthetic dyes, 2-aminophenylboronic acid, 4-aminobenzamidine, glutathione, biotin, and derivative thereof. The above-exemplified ligands may be used as a whole molecule, or the fragments thereof obtainable by, for example, subjecting them to recombination or enzyme treatment may also be used. Further, artificially synthesized peptides or peptide derivatives may also be used.

Among these ligands, when a refined target substance is an antibody, those containing an amino group are preferable, proteins and peptides are more preferable, proteins are even more preferable, and an immunoglobulin-binding protein is even more preferable. As the immunoglobulin-binding protein, at least one or more selected from the group consisting of Protein A, Protein G, Protein L, Fc binding protein, and functional mutants thereof are preferable. Among these, Protein A, Protein G, and functional mutants thereof are preferable, and Protein A and functional mutants thereof are more preferable.

The binding amount of the ligand is preferably 10 to 200 mg and more preferably 25 to 100 mg per gram of the solid-phase carrier.

Examples of the reactive group for binding a ligand include a cyclic ether group, a carboxy group, a succinimidoxy group, a formyl group, an isocyanate group, and an amino group. Among these, a cyclic ether group is preferable, a cyclic ether group having 3 to 7 atoms that form a ring is more preferable, a monovalent group represented by the following Formula (23), (24) or (25) is even more preferable, and a monovalent group represented by the following Formula (23) is particularly preferable.

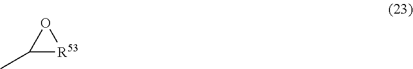

[In Formula (23),

R⁵³ represents a divalent hydrocarbon group having 1 to 6 carbon atoms.]

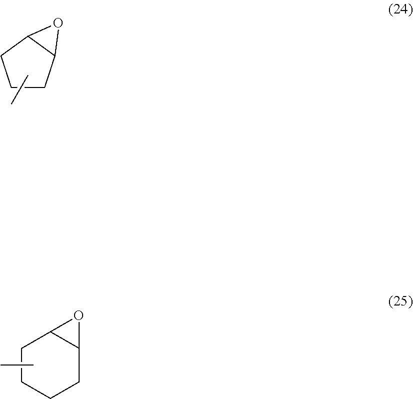

R⁵³ in Formula (23) represents a divalent hydrocarbon group having 1 to 6 carbon atoms. The number of carbon atoms of such a divalent hydrocarbon group is preferably 1 to 4, more preferably 1 or 2, and particularly preferably 1. Further, the divalent hydrocarbon group may be a linear chain or a branched chain.

Further, the divalent hydrocarbon group is preferably a divalent aliphatic hydrocarbon group and more preferably an alkanediyl group. Preferred specific examples thereof include a methane-1,1-diyl group, an ethane-1,1-diyl group, and an ethane-1,2-diyl group.

Further, the polymer constituting the solid-phase carrier is not particularly limited as long as it has the terminal structure in the terminal of the polymer chain through a thio group, a sulfinyl group or a sulfonyl group, and may be a natural polymer consisting of polysaccharides such as agarose, dextran, and cellulose, or may be a synthetic polymer.

As the polymer constituting the solid-phase carrier, a polymer having a structural unit derived from an ethylenically unsaturated monomer is preferable. Examples thereof include a polymer having a structural unit derived from one or two or more monomers selected from the group consisting of a styrene-based monomer, a vinyl ketone-based monomer, a (meth)acrylonitrile-based monomer, a (meth)acrylate-based monomer, and a (meth)acrylamide-based monomer.

Further, regarding the form of the solid-phase carrier, any form of a monolith, a film, a hollow fiber, a particle, a cassette, or a chip may be employed, and a particle form is preferable. Further, from the viewpoint of improving a surface area, the solid-phase carrier is preferably formed into a porous body such as porous particles. Further, as porous particles, porous polymer particles are preferable.

When the solid-phase carrier constituting the carrier D for affinity refining of the present invention is particles, the average particle diameter (volume average particle diameter) thereof is generally 35 to 100 μm and preferably 40 to 85 μm. When the average particle diameter is set to 35 μm or more, pressure characteristics are improved. In addition, when the average particle diameter is set to 100 μm or less, the dynamic binding capacity when the ligand is bound increases. Further, the variation coefficient of the average particle diameter is preferably 40% or less and more preferably 30% or less.

The average particle diameter can be adjusted by the conditions at the time of polymerization. The average particle diameter can be measured by, for example, a laser diffraction/scattering particle size analysis measurement apparatus.

### (Production Method of Carrier D for Affinity Refining)

The production method of the carrier D for affinity refining of the present invention can be performed by appropriately combining it with normal methods.

For example, the carrier D for affinity refining can be produced by (Step P1) of (co)polymerizing a monomer having a reactive group for binding a ligand and, as necessary, a monomer other than the monomer having a reactive group (hereinafter, also referred to as another monomer) in the presence of a thiol compound and a polymerization inhibitor, and as necessary, (Step P2-1) of performing crosslinking reaction using a cross-linking agent or (Step P2-2) of oxidizing a thio group to a sulfinyl group using an oxidant. In addition, a ligand may be bound to the solid-phase carrier obtained by the method as (Step P3).

### (Step P1)

As a monomer having a reactive group for binding a ligand and another monomer, even in the both cases, an ethylenically unsaturated monomer is exemplified. Specific examples thereof may include one or two or more monomers selected from a styrene-based monomer, a vinyl ketone-based monomer, a (meth)acrylonitrile-based monomer, a (meth)acrylate-based monomer, and a (meth)acrylamide-based monomer.

As the monomer having a reactive group for binding a ligand, a monomer having a reactive group selected from the group consisting of a monovalent group represented by the above Formula (23), a monovalent group represented by the above Formula (24), a monovalent group represented by the above Formula (25), a carboxy group, a succinimidoxy group, a formyl group, an isocyanate group, and an amino group is preferable and a monomer having a monovalent group represented by Formula (23) is more preferable. Examples of the monomer having a monovalent group represented by Formula (23) include an epoxy group-containing unsaturated monomer. As the epoxy group-containing unsaturated monomer, for example, a (meth)acrylate-based monomer or a styrene-based monomer is preferable, a (meth)acrylate-based monomer is more preferable, and a (meth)acrylate-based monomer represented by the following Formula (26) is even more preferable.

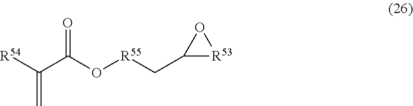

[In Formula (26),

R⁵⁴ represents a hydrogen atom or a methyl group,

R⁵⁵ represents a single bond, a divalent hydrocarbon group having 1 to 10 carbon atoms or —(R⁵⁶O)ₖ₂— (R represents an alkanediyl group having 2 to 4 carbon atoms and k2 represents an integer of 1 to 50), and

R⁵³ has the same meaning as defined above and represents a divalent hydrocarbon group having 1 to 6 carbon atoms.]

The number of carbon atoms of the divalent hydrocarbon group represented by R⁵⁵ is preferably 1 to 8, more preferably 1 to 6, and even more preferably 1 to 4. The divalent hydrocarbon group may be a linear chain or a branched chain.

Further, the divalent hydrocarbon group is preferably a divalent aliphatic hydrocarbon group and more preferably an alkanediyl group. The number of carbon atoms of such an alkanediyl group is preferably 1 to 8, more preferably 1 to 6, and even more preferably 1 to 4.

Specific examples of the alkanediyl group include a methane-1,1-diyl group, an ethane-1,1-diyl group, an ethane-1,2-diyl group, a propane-1,1-diyl group, a propane-1,2-diyl group, a propane-1,3-diyl group, and a propane-2,2-diyl group.

The number of carbon atoms of the alkanediyl group represented by R⁵⁶ is preferably 2 or 3 and more preferably 2. Further, such an alkanediyl group may be a linear chain or a branched chain. Specific examples thereof include an ethane-1,1-diyl group, an ethane-1,2-diyl group, a propane-1,1-diyl group, a propane-1,2-diyl group, a propane-1,3-diyl group, a propane-2,2-diyl group, a butane-1,2-diyl group, a butane-1,3-diyl group, and a butane-1,4-diyl group.

Further, k2 represents an integer of 1 to 50, and is preferably an integer of 1 to 30, more preferably an integer of 1 to 25, even more preferably an integer of 1 to 20, even more preferably an integer of 1 to 15, even more preferably an integer of 1 to 10, even more preferably an integer of 1 to 5, and particularly preferably an integer of 1 to 3.

Further, among R⁵⁵s as described above, a single bond is preferable.

Specific examples of a monomer having a reactive group for binding a ligand include glycidyl(meth)acrylate, 4-hydroxybutyl(meth)acrylate glycidyl ether, α-(meth)acryl-α-glycidyl polyethylene glycol, (4-vinylbenzyl)glycidyl ether, (7-oxabicyclo[4.1.0]heptan-3-yl)methyl(meta)acrylate, allyl glycidyl ether, 3,4-epoxy-1-butene, and 3,4-epoxy-3-methyl-1-butene, and these can be used alone or in combination of two or more thereof.

Further, from the viewpoint of dynamic binding capacity when a ligand is immobilized and an amount of a ligand which can be immobilized, the total used amount of the monomer having a reactive group for binding a ligand is preferably 1 to 90 parts by mass, more preferably 20 to 80 parts by mass, even more preferably 30 to 70 parts by mass, and particularly preferably 40 to 60 parts by mass, with respect to 100 parts by mass of the total amount of the monomer.

Further, as another monomer, anyone of a non-crosslinkable monomer and a crosslinkable monomer can be used and these monomers may be used in combination.

Further, examples of the non-crosslinkable monomer include a hydroxyl group-containing non-crosslinkable unsaturated monomer and a non-crosslinkable unsaturated monomer not containing a hydroxyl group, and examples of the crosslinkable monomer include a hydroxyl group-containing crosslinkable unsaturated monomer and a crosslinkable unsaturated monomer not containing a hydroxyl group.

As the hydroxyl group-containing non-crosslinkable unsaturated monomer, for example, a (meth)acrylate-based monomer or a (meth)acrylamide-based monomer is preferable. Further, the number of hydroxyl groups contained in the hydroxyl group-containing non-crosslinkable unsaturated monomer is preferably 1 to 5 and more preferably 1 to 3. Further, as the (meth)acrylate-based monomer, a (meth)acrylate-based monomer represented by the following Formula (27) is preferable.

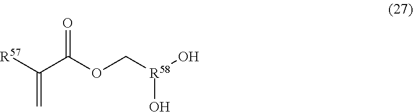

[In Formula (27),

R⁵⁷ represents a hydrogen atom or a methyl group, and

R⁵⁰ represents a trivalent hydrocarbon group having 1 to 6 carbon atoms.]

The trivalent hydrocarbon group represented by R⁵⁸ may be a linear chain or a branched chain. Further, the number of carbon atoms thereof is preferably 2 to 4.

Further, the trivalent hydrocarbon group is preferably a trivalent aliphatic hydrocarbon group and more preferably an alkanetriyl group. Specific examples thereof include an ethane-1,1,2-triyl group.

Specific examples of the hydroxyl group-containing non-crosslinkable unsaturated monomer include glycerol mono(meth)acrylate, trimethylolethane mono(meth)acrylate, trimethylolpropane mono(meth)acrylate, butanetriol mono(meth)acrylate, polyethylene glycol mono(meth)acrylate, pentaerythritol mono(meth)acrylate, dipentaerythritol mono(meth)acrylate, inositol mono(meth)acrylate, hydroxyethyl(meth) acrylate, hydroxypropyl(meth)acrylate, and hydroxyethyl(meth)acrylamide, and these can be used alone or in combination of two or more thereof.

Further, when the hydroxyl group-containing non-crosslinkable unsaturated monomer is used, from the viewpoint of preventing aggregation in production, the total used amount thereof is preferably 1 to 30 parts by mass, more preferably 2 to 20 parts by mass, and particularly preferably 3 to 15 parts by mass, with respect to 100 parts by weight of the total amount of the monomer.

Further, as the non-crosslinkable unsaturated monomer not containing a hydroxyl group, for example, a (meth)acrylate-based monomer or a (meth)acrylamide-based monomer is preferable. Further, as the (meth)acrylate-based monomer, a (meth)acrylate-based monomer represented by the following Formula (28) is more preferable.

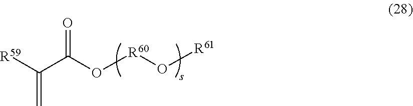

[In Formula (28),

R⁵⁹ represents a hydrogen atom or a methyl group,

R⁶⁰ represents an alkanediyl group having 2 to 4 carbon atoms,

R⁶¹ represents a monovalent hydrocarbon group having 1 to 6 carbon atoms, and

s represents an integer of 0 to 50.]

The number of carbon atoms of the alkanediyl group represented by R⁶⁰ is preferably 2 or 3 and more preferably 2. Further, such an alkanediyl group may be a linear chain or a branched chain. Specific examples thereof include an ethane-1,1-diyl group, an ethane-1,2-diyl group, a propane-1,1-diyl group, a propane-1,2-diyl group, a propane-1,3-diyl group, a propane-2,2-diyl group, a butane-1,2-diyl group, a butane-1,3-diyl group, and a butane-1,4-diyl group.

The number of carbon atoms of the monovalent hydrocarbon group represented by R⁶¹ is preferably 1 to 4 and more preferably 1 or 2.

The monovalent hydrocarbon group encompasses the concept including a monovalent aliphatic hydrocarbon group, a monovalent alicyclic hydrocarbon group, and a monovalent aromatic hydrocarbon group, and a monovalent aliphatic hydrocarbon group is preferable. The monovalent aliphatic hydrocarbon group may be a linear chain or a branched chain.

An alkyl group is preferable as the monovalent aliphatic hydrocarbon group. The number of carbon atoms of such an alkyl group is preferably 1 to 4 and more preferably 1 or 2. Specific examples of the alkyl group include a methyl group, an ethyl group, an n-propyl group, an isopropyl group, an n-butyl group, an isobutyl group, a sec-butyl group, a tert-butyl group, a pentyl group, and a hexyl group.

s represents an integer of 0 to 50, and is preferably an integer of 1 to 25 and more preferably an integer of 1 to 15.

Specific examples of the non-crosslinkable unsaturated monomer not containing a hydroxyl group include methoxypolyethylene glycol(meth)acrylate, methyl(meth)acrylate, ethyl(meth)acrylate, butyl(meth)acrylate, cyclohexyl(meth)acrylate, methoxyethyl(meth)acrylate, (meth)acrylamide, dimethyl(meth)acrylamide, (meth)acryloylmorpholine, and diacetone(meth)acrylamide, and these can be used alone or in combination of two or more thereof.

Further, from the viewpoint of dynamic binding capacity, the total used amount of the non-crosslinkable unsaturated monomer not containing a hydroxyl group is preferably 0 to 70 parts by mass, more preferably 0 to 30 parts by mass, and particularly preferably 0 to 20 parts by mass, with respect to 100 parts by mass of the total amount of the monomer.

Further, the number of hydroxyl groups contained in the hydroxyl group-containing crosslinkable unsaturated monomer is preferably 1 to 5 and more preferably 1 to 3, from the viewpoint of dynamic binding capacity and antifouling properties. Further, as the hydroxyl group-containing crosslinkable unsaturated monomer, those having a reactive group with a functionality of 2 to 5 are preferable and those having a reactive group with a functionality of 2 or 3 are more preferable.

Further, as the hydroxyl group-containing crosslinkable unsaturated monomer, a (meth)acrylate-based monomer is preferable and a (meth)acrylate-based monomer represented by the following Formula (29) is more preferable.

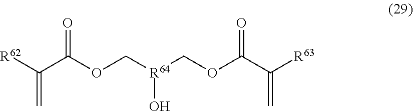

[In Formula (29),

R⁶² and R⁶³ each independently represent a hydrogen atom or a methyl group, and

R⁴ represents a trivalent hydrocarbon group having 1 to 8 carbon atoms.]

The trivalent hydrocarbon group represented by R⁶⁴ may be a linear chain or a branched chain. Further, the number of carbon atoms thereof is preferably 1 to 5.

Further, the trivalent hydrocarbon group is preferably a trivalent aliphatic hydrocarbon group and more preferably an alkanetriyl group. Specific examples thereof include a methane-1,1,1-triyl group.

Specific examples of the hydroxyl group-containing crosslinkable unsaturated monomer include glycerin di(meth)acrylate, trimethylolethane di(meth)acrylate, trimethylolpropane di(meth)acrylate, butanetriol di(meth)acrylate, pentaerythritol di(meth)acrylate, pentaerythritol tri(meth)acrylate, dipentaerythritol di(meth)acrylate, dipentaerythritol tri(meth)acrylate, dipentaerythritol tetra(meth)acrylate, dipentaerythritol penta(meth)acrylate, inositol di(meth)acrylate, inositol tri(meth)acrylate, and inositol tetra(meth)acrylate, and these can be used alone or in combination of two or more thereof.

Further, when the hydroxyl group-containing crosslinkable unsaturated monomer is used, from the viewpoint of dynamic binding capacityand antifouling properties, the total used amount thereof is preferably 1 to 70 parts by mass, more preferably 10 to 50 parts by mass, and preferably 15 to 40 parts by mass, with respect to 100 parts by mass of the total amount of the monomer.

Further, as the crosslinkable unsaturated monomer not containing a hydroxyl group, those having a reactive group with a functionality of 2 to 5 are preferable and those having a reactive group with a functionality of 2 or 3 are more preferable. Further, as the crosslinkable unsaturated monomer not containing a hydroxyl group, a (meth)acrylate-based monomer is preferable and a (meth)acrylate-based monomer represented by the following Formula (30) or (31) is more preferable.

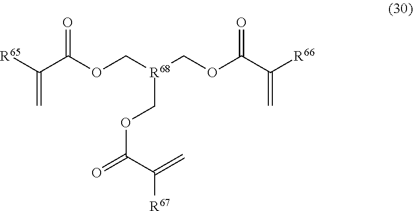

[In Formula (30),

R⁶⁵ to R⁶⁷ each independently represent a hydrogen atom or a methyl group, and

R⁶⁸ represents a trivalent hydrocarbon group having 1 to 6 carbon atoms.]

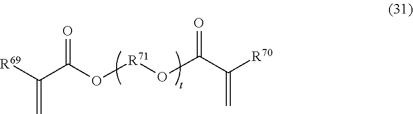

[In Formula (31),

R⁶⁹ and R⁷⁰ each independently represent a hydrogen atom or a methyl group,

R⁷¹ represents an alkanediyl group having 2 to 4 carbon atoms, and

t represents an integer of 1 to 50.]

The trivalent hydrocarbon group represented by R⁶⁸ in Formula (30) may be a linear chain or a branched chain. Further, the number of carbon atoms thereof is preferably 2 to 4.

Further, the trivalent hydrocarbon group is preferably a trivalent aliphatic hydrocarbon group and more preferably an alkanetriyl group. Specific examples thereof include a propane-1,1,1-triyl group.

Further, the number of carbon atoms of the alkanediyl group represented by R⁷¹ in Formula (31) is preferably 2 or 3 and more preferably 2. Further, such an alkanediyl group may be a linear chain or a branched chain. Specific examples thereof include an ethane-1,1-diyl group, an ethane-1,2-diyl group, a propane-1,1-diyl group, a propane-1,2-diyl group, a propane-1,3-diyl group, a propane-2,2-diyl group, a butane-1,2-diyl group, a butane-1,3-diyl group, and a butane-1,4-diyl group.

Further, t represents an integer of 1 to 50, and is preferably an integer of 1 to 30, more preferably an integer of 1 to 25, even more preferably an integer of 1 to 20, even more preferably an integer of 1 to 15, and particularly preferably an integer of 1 to 10.

Specific examples of the crosslinkable unsaturated monomer not containing a hydroxyl group include trimethylolpropane tri(meth)acrylate, ethylene glycol di(meth)acrylate, polyethylene glycol di(meth)acrylate including two or more ethylene glycols, polypropylene glycol di(meth)acrylate, polypropylene glycol di(meth)acrylate including two or more ethylene glycols, 1,4-butanediol di(meth)acrylate, 1,6-hexanediol di(meth)acrylate, and pentaerythritol tetra(meth)acrylate, and these can be used alone or in combination of two or more thereof.

Further, when the crosslinkable unsaturated monomer not containing a hydroxyl group is used, from the viewpoint of dynamic binding capacity and antifouling properties, the total used amount thereof is preferably 1 to 90 parts by mass, more preferably 5 to 70 parts by mass, even more preferably 10 to 60 parts by mass, and particularly preferably 20 to 50 parts by mass, with respect to 100 parts by mass of the total amount of the monomer.

The (co)polymerization in Step P1 is performed in the presence of a thiol compound, and the addition of the thiol compound may be performed before polymerization or during polymerization. By the addition of the thiol compound, propagation carbon radicals during a radical polymerization easily react in association with hydrogen abstraction from the thiol compound, so that a hydrogen-terminated polymer and a sulfur radical are generated. By the reinitiation from the sulfur radicals, a polymer chain is formed again. In this way, the thiol compound acts as a chain transfer agent and a residual group derived from the thiol compound is introduced in the terminal of the generated polymer. A hydrophilicity of the thus-obtained carrier increases, impurities such as a host cell protein (HCP) are unlikely to be non-specifically absorbed, and dynamic binding capacity when a ligand is bound increases as well.

Examples of the thiol compound include thioglycerol, 2-mercaptoethanol, 3-mercapto-2-butanone, 3-mercapto-1-propanol, and 3-mercaptoisobutyric acid, and these can be used alone and in combination of two or more thereof. Further, a polyfunctional thiol compound having two or more thiol groups may be used. When the thiol compound is used, dynamic binding capacity when a ligand is bound is expected to be improved by variation of pore distribution in polymerization or hydrophilization of the particle surface.

The used amount of the thiol compound is preferably 0.01 to 200 parts by mass, more preferably 1 to 150 parts by mass, and particularly preferably 10 to 100 parts by mass, with respect to 100 parts by mass of the total amount of the monomer.

The addition of the thiol compound may be performed before polymerization or during polymerization as described above. However, when the thiol compound is added at the same time as the input of the polymerization initiator or after the input of the polymerization initiator, the thiol compound is added preferably within 0 to 5 hours, more preferably within 0 to 3 hours, and even more preferably within 0 to 1 hour from the input of the polymerization initiator. In addition, the addition of the thiol compound may be performed in the presence of a basic catalyst.

As the polymerization initiator used for polymerizing the monomer, radical polymerization initiators are preferable. Examples of the radical polymerization initiators include azo-based initiators, peroxide-based initiators, and redox-based initiator, and specific examples thereof include azobisisobutyronitrile, methyl azobisisobutyrate, azobis-2,4-dimethyl valeronitrile, benzoyl peroxide, di-tert-butyl peroxide, and benzoyl peroxide-dimethylaniline.

The total used amount of the polymerization initiator is generally about 0.01 to 10 parts by mass with respect to 100 parts by mass of the total amount of the monomer.

Further, the (co)polymerization reaction in Step P1 is preferably suspension polymerization. Examples of specific method of suspension polymerization include a method of dissolving a polymerization initiator in a mixed solution containing a monomer and, as necessary, a pore-forming agent (monomer solution), suspending the resultant solution in an aqueous medium, and polymerizing the suspended solution by heating to a predetermined temperature, a method of dissolving a polymerization initiator in a mixed solution containing a monomer and, as necessary, a pore-forming agent (monomer solution), adding the resultant solution to an aqueous medium which has been heated to a predetermined temperature, and polymerizing the resultant mixture, and a method of suspending a mixed solution containing a monomer and, as necessary, a pore-forming agent (monomer solution) in an aqueous medium, heating the suspended solution to a predetermined temperature, and polymerizing the resultant solution by adding a polymerization initiator.

Examples of the pore-forming agent include aliphatic hydrocarbons such as hexane, heptane, octane, nonane, decane, and undecane; alicyclic hydrocarbons such as cyclohexane and cyclopentane; aromatic hydrocarbons such as benzene, toluene, xylene, naphthalene, and ethylbenzene; halogenated hydrocarbons such as carbon tetrachloride, 1,2-dichloroethane, tetrachloroethane, and chlorobenzene; aliphatic alcohols such as butanol, pentanol, hexanol, heptanol, hexanol, 4-methyl-2-pentanol, and 2-ethyl-1-hexanol; alicyclicalcohols such as cyclohexanol; aromatic alcohols such as 2-phenylethyl alcohol and benzyl alcohol; ketones such as diethyl ketone, methyl isobutyl ketone, diisobutyl ketone, acetophenone, 2-octanone, and cyclohexanone; ethers such as dibutyl ether, diisobutyl ether, anisole, and ethoxybenzene; and esters such as isopentyl acetate, butyl acetate, 3-methoxybutyl acetate, and diethyl malonate, as well as linear polymers such as homopolymers of non-crosslinkable vinyl monomers. These pore-forming agents can be used alone or in combination of two or more thereof.

The total used amount of the pore-forming agent is generally about 40 to 400 parts by mass with respect to 100 parts by mass of the total amount of the monomer.

Examples of the aqueous medium include aqueous solutions of water-soluble polymers, and examples of the water-soluble polymers include hydroxyethyl cellulose, polyvinyl alcohol, carboxymethyl cellulose, polyvinylpyrrolidone, starch, and gelatin.

The total used amount of the aqueous medium is generally about 200 to 7000 parts by mass with respect to 100 parts by mass of the total amount of the monomer.

Further, when water is used as the dispersion medium of the aqueous medium, for example, a dispersion stabilizer such as sodium chloride, sodium sulfate, sodium carbonate, calcium carbonate, or calcium phosphate may be used.

Further, in the polymerization reaction of Step P1, various surfactants including anionic surfactants such as alkyl sulfate salts, alkylaryl sulfate salts, alkyl phosphate salts, and fatty acid salts may be used.

Further, a polymerization inhibitor such as a nitrite salt (for example, sodium nitrite), an iodide salt (for example, potassium iodide), tert-butylpyrocatechol, benzoquinone, picric acid, hydroquinone, copper chloride, or ferric chloride can also be used.

Further, the polymerization temperature may depends on a polymerization initiator, and for example, is generally about 2 to 100° C. When azobisisobutyronitrile is used as a polymerization initiator, the polymerization temperature is preferably 50 to 100° C. and more preferably 60 to 90° C.

Further, the polymerization time is generally 5 minutes to 48 hours and preferably 10 minutes to 24 hours.

### (Step P2-1)

Step P2-1 is a crosslinking reaction in which a cross-linking agent is subjected to ring-opening addition at a part of the reactive group for binding a ligand derived from the monomer having a reactive group for binding a ligand, and the cross-linked structure derived from the cross-linking agent is introduced into the solid-phase carrier. By this reaction, the cross-linked structure is formed, for example, on the surface of the solid-phase carrier. When such a specific cross-linked structure is introduced into the solid-phase carrier, a balance between high hydrophilicity and excellent pressure resistance performance is achieved.

As the cross-linking agent, a multivalent of di- to hexavalent cross-linking agent is preferable, a di- or trivalent cross-linking agent is more preferable, and a cross-linking agent represented by the following Formula (22) is preferable.

X¹¹—R⁵²—X¹² (22)

[In Formula (22),

R⁵² represents a divalent organic group having 1 to 10 carbon atoms, and

X¹¹ and X¹² each independently represent a hydroxyl group, an amino group or a thiol group.]

The divalent organic group represented by R⁵² may be a linear chain or a branched chain. Further, examples of such a divalent organic group include a divalent hydrocarbon group and a group having one or more selected from the group consisting of an ether bond, an imino group and an ester bond between carbon-carbon atoms of the divalent hydrocarbon group.

Further, when the divalent organic group is a divalent hydrocarbon group, the number of carbon atoms thereof is preferably 1 to 20, more preferably 1 to 10, even more preferably 1 to 6, and particularly preferably 2 to 6. Further, the divalent hydrocarbon group may be a linear chain or a branched chain.

Further, the divalent hydrocarbon group is preferably a divalent aliphatic hydrocarbon group and more preferably an alkanediyl group.

Specific examples of the alkanediyl group include a methane-1,1-diyl group, an ethane-1,1-diyl group, an ethane-1,2-diyl group, a propane-1,1-diyl group, a propane-1,2-diyl group, a propane-1,3-diyl group, a propane-2,2-diyl group, a butane-1,4-diyl group, a pentane-1,5-diyl group, and a hexane-1,6-diyl group.

Further, as the group having one or more selected from the group consisting of an ether bond, an imino group and an ester bond between carbon-carbon atoms of the divalent hydrocarbon group, a group having an ether bond between carbon-carbon atoms of the divalent hydrocarbon group is preferable and a group represented by —R^{a} (OR^{b})_{q}OR^{c}— (R^{a}, R^{b}, and R^{c} each independently represent an alkanediyl group having 2 to 4 carbon atoms and q represents an integer of 0 to 30) is more preferable.

The number of carbon atoms of the alkanediyl group represented by R^{a}, R^{b}, and R^{c} is preferably 2 or 3 and more preferably 2. Further, such an alkanediyl group may be a linear chain or a branched chain, and preferred specific examples thereof include an ethane-1,2-diyl group, a propane-1,2-diyl group, and a propane-1,3-diyl group.

Further, q represents an integer of 0 to 30, and is preferably an integer of 0 to 25, more preferably an integer of 0 to 20, even more preferably an integer of 0 to 15, even more preferably an integer of 0 to 10, even more preferably an integer of 0 to 5, and particularly preferably an integer of 0 to 3.

X¹¹ and X¹ each independently represent a hydroxyl group, an amino group or a thiol group, and are preferably a thiol group.

Examples of the type of the cross-linking agent include 1,2-ethanedithiol, 1,3-propanedithiol, 3,6-dioxa-1,8-octanedithiol, 2,3-dimercapto-1-propanol, bis(2-mercaptoethyl) sulfide, tris(mercaptoacetate)trimethylolpropane, bis(mercaptoacetate)ethylene glycol, and (±)-dithiothreitol.

The reaction temperature of the crosslinking reaction is generally 25 to 200° C. and preferably 50 to 100° C. The reaction time of the crosslinking reaction is generally 30 minutes to 24 hours and preferably 1 to 12 hours.

### (Step P2-2)

Step P2-2 is a step of oxidizing a thio group derived from a thiol compound or a thio group in the cross-linked structure by, for example, using an oxidant. By Step P2-2, the thio group is oxidized to a sulfinyl group or a sulfonyl group, and is preferably oxidized to a sulfinyl group.

The oxidant is roughly divided into an organic oxidant and an inorganic oxidant, and examples of the organic oxidant include peracetic acid, perbenzoic acid, and m-chloroperbenzoic acid. Meanwhile, examples of the inorganic oxidant include hydrogen peroxide, chromic acid, and permanganate. These oxidant scan be used alone or in combination of two or more thereof.

Further, the total used amount of the oxidant is generally about 0.1 to 10 molar equivalent and preferably 0.5 to 3 molar equivalent per mole of the thio group.

Further, the oxidization reaction is preferably performed in the presence of a solvent. Examples of such a solvent include water; amide-based solvents such as dimethylformamide and dimethylacetamide; and alcohol-based solvents such as methanol and ethanol, and these can be used alone or in combination of two or more thereof.

The total used amount of the solvent is generally about 1 to 50 times by mass and preferably 5 to 15 times by mass with respect to the solid-phase carrier as a raw material.

Further, the reaction time of the oxidation reaction is not particularly limited, and is generally about 1 to 72 hours, and the reaction temperature may be appropriately selected from a temperature equal to or lower than a boiling point of the solvent, and is generally about 1 to 90° C.

The solid-phase carrier obtained by each step described above can be obtained by removing the pore-forming agent and the unreacted monomer by, for example, distillation, extraction or washing, as necessary.

### (Step P3)

The fixation of the ligand may be performed in the same manner as a normal method, except that the solid-phase carrier obtained above is used, and is preferably performed under a buffer with a salt added. Examples of the type of the salt include trisodium citrate and sodium sulfate. Examples of the buffer include sodium phosphate, potassium phosphate, and boric acid. The total used amount of the buffer is generally about 20 to 80 times by mass and preferably 35 to 45 times by mass with respect to the solid-phase carrier as a raw material.

Further, the reaction time is not particularly limited and is generally about 0.5 to 72 hours, and the reaction temperature is generally about 1 to 40° C.

The carrier to which the ligand is fixed may be brought into contact with a thiol compound and the unreacted reactive group may be ring-opened.

Further, the carrier D for affinity refining of the present invention has a high hydrophilicity and excellent antifouling properties and is unlikely to have the non-specific adsorption of impurities such as a host cell protein (HCP). Moreover, the carrier D for affinity refining exhibits high dynamic binding capacity when a ligand is immobilized. Therefore, the carrier D for affinity refining of the present invention is useful as a carrier for a filler for a chromatography column.

### <Chromatography Column>

In the chromatography column of the present invention, a column container is filled with a filler for affinity chromatography obtained by the production methodCof the present invention, or a filler for a chromatography column having the carrier D for affinity refining of the present invention as a carrier. The chromatography column is suitable for use in affinity chromatography.

### <Method for Refining Target Substance>

The method for refining a target substance of the present invention is characterized by including a step of preparing a composition containing a target substance and a step of causing the composition to pass through the chromatography column. Examples of the target substance include proteins.

Further, the refining may be performed in accordance with a normal method, except that the chromatography column of the present invention is used. For example, a method includes a preparing step of preparing a composition containing a target substance, a passing step of causing the composition to pass through the chromatography column, and an elution step of eluting the target substance adsorbed to the carrier by the passing step. After the elution, a filler may be subjected to an alkali washing.

The refining method of the present invention is suitable for refining proteins and particularly suitable for refining immunoglobulins.

### EXAMPLES

Hereinafter, the present invention will be described in detail by means of examples, however, the present invention is not limited to these examples.

Each analysis condition in Examples 1 to 5 and Comparative Examples 1 and 2 will be described below.

### (Volume Average Particle Diameter)

The average particle diameter was measured using a laser diffraction scattering type particle size distribution analyzer (LS13320 manufactured by Beckman Coulter, Inc.).

### (Specific Surface Area)

The specific surface area was measured using a mercury porosimeter (Autopore IV9520 manufactured by Shimadzu Corporation) and the measurement range of the fine pore diameter was set to 10 to 5000 nm.

### Example 1

### Example 1-1

(1) To 360 g of pure water, 0.72 g of polyvinyl alcohol (PVA-217 manufactured by Kuraray Co., Ltd.) was added and heated under stirring to dissolve polyvinyl alcohol, the resultant solution was cooled, and then 0.18 g of sodium dodecyl sulfate (EMAL 10G manufactured by Kao Corporation), 0.36 g of sodium carbonate (manufactured by Wako Pure Chemical Industries, Ltd.), and 0.18 g of sodium nitrite (manufactured by Wako Pure Chemical Industries, Ltd.) were added thereto and stirred to prepare an aqueous solution (S-1).

Meanwhile, a monomer composition consisting of 6.88 g of glycidyl methacrylate (manufactured by Mitsubishi Rayon Co., Ltd.), 1.37 g of glycerol monomethacrylate (manufactured by NOF CORPORATION), 4.12 g of trimethylolpropane trimethacrylate (manufactured by Sartomer USA LLC.), and 1.37 g of polyethylene glycol #400 dimethacrylate (manufactured by Shin Nakamura Chemical Co., Ltd., 9G) was dissolved in a mixed solution of 20.63 g of 2-octanone (manufactured by Toyo Gosei Co., Ltd.) and 5.30 g of acetophenone (manufactured by INOUE PERFUMERY MFG. CO., LTD.) to prepare a monomer solution (M-1).

Subsequently, the entire amount of the aqueous solution (S-1) was fed into a 500 mL separable flask, the separable flask was equipped with a thermometer, a stirring blade, and a cooling tube and was set to a hot water bath, and stirring was started under a nitrogen atmosphere. The entire amount of the monomer solution (M-1) was fed into the separable flask, the separable flask was heated by the hot water bath, 0.53 g of 2,2′-azoisobutyronitrile (manufactured by Wako Pure Chemical Industries, Ltd.) was added thereto when the internal temperature reached 85° C., and the internal temperature was maintained at 86° C.

(2) Thereafter, 31.39 g of thioglycerol (manufactured by ASAHI KAGAKU KOGYO Co., Ltd.) was added to the reaction solution, and while the temperature was maintained at 86° C., stirring was performed for 3 hours to obtain thioglycerol-treated particles (PA-1).

Subsequently, the reaction solution was cooled, and then this reaction solution was filtered and washed with pure water and ethanol. The washed particles (PA-1) were dispersed in pure water and decantation was carried out three times to remove small particles. The particles thus obtained were used as thioglycerol-treated particles (PA-2).

Subsequently, the particles were dispersed in pure water such that the concentration of the particles became 10% by mass, thereby obtaining a dispersion solution of the thioglycerol-treated particles (PA-2) corresponding to the solid-phase carrier A of the present invention. The dispersion solution thus obtained was used as a dispersion solution (L-1)

### Example 1-2

After 4.30 g of hydrogen peroxide (manufactured by Wako Pure Chemical Industries, Ltd.) was added to the dispersion solution (L-1) obtained in Example 1-1, inversion mixing was performed for 24 hours at 25° C. so that the particles were sulfoxidated. Thereafter, this reaction solution was filtered and washed with pure water. Subsequently, the particles were dispersed in pure water such that the concentration of the particles became 10% by mass, thereby obtaining a dispersion solution of sulfoxidated particles (PA-3) corresponding to the solid-phase carrier A of the present invention. The dispersion solution thus obtained was used as a sulfoxidated particle dispersion solution (L-2).

### Example 1-3

0.15 g of modified Protein A represented by amino acid sequence of SEQ ID NO. 2 which was prepared by introducing a vector where DNA containing the base sequence represented by SEQ ID NO. 1 was inserted in pET-24(a) in a host (Escherichia coli BL21 (DE3)) and in which genetically modified Escherichia coli was expressed, was dispersed in 40 mL of buffer (pH 6.6) of 1.0 M trisodium citrate/0.1 M sodium phosphate to obtain a Protein A dispersion solution. The sulfoxidated particle dispersion solution (L-2) obtained in Example 1-2 (1 g in terms of dry particle mass) was added to this Protein A dispersion solution. The obtained dispersion solution was stirred with shaking for 5 hours at 25° C. so that Protein A was fixed to the particles.

The generated Protein A-fixed particles were washed with a 0.1 M sodium phosphate buffer (pH 7.6) and then dispersed in 40 mL of aqueous solution (pH 8.3) of 1.0 M thioglycerol/0.1 M sodium sulfate, and stirring with shaking was carried out for 17 hours at 25° C. so that an unreacted epoxy group was ring-opened by an excessive amount of thioglycerol.

Thereafter, washing was sequentially performed with a 0.1 M sodium phosphate buffer (pH 7.6), a 0.5 M sodium hydroxide aqueous solution, and a 0.1 M sodium citrate buffer (pH 3.2) to obtain a filler 1 for affinity chromatography.

The volume average particle diameter of the filler 1 for affinity chromatography was 64 m and the specific surface area thereof was 93 m²/g.

### Example 2

0.15 g of modified Protein A represented by amino acid sequence of SEQ ID NO. 2 which was prepared by introducing a vector where DNA containing the base sequence represented by SEQ ID NO. 1 was inserted in pET-24(a) in a host (Escherichia coli BL21 (DE3)) and in which genetically modified Escherichia coli was expressed, was dispersed in 40 mL of buffer (pH 6.6) of 1.0 M trisodium citrate/0.1 M sodium phosphate to obtain a Protein A dispersion solution, and the dispersion solution (L-1) obtained in Example 1-1 (1 g in terms of dry particle mass) was added to this Protein A dispersion solution. The obtained dispersion solution was stirred with shaking for 5 hours at 25° C. so that Protein A was fixed to the particles.

The generated Protein A-fixed particles were washed with a 0.1 M sodium phosphate buffer (pH 7.6) and then dispersed in 40 mL of aqueous solution (pH 8.3) of 1.0 M thioglycerol/0.1 M sodium sulfate, and stirring with shaking was carried out for 17 hours at 25° C. so that an unreacted epoxy group was ring-opened by an excessive amount of thioglycerol.

Thereafter, washing was sequentially performed with a 0.1 M sodium phosphate buffer (pH 7.6), a 0.5 M sodium hydroxide aqueous solution, and a 0.1 M sodium citrate buffer (pH 3.2) to obtain a filler 2 for affinity chromatography.

The volume average particle diameter of the filler 2 for affinity chromatography was 64 m and the specific surface area thereof was 92 m²/g.

### Example 3

A filler 3 for affinity chromatography was obtained by the same operations as in Examples 1-1 to 1-3, except that the monomer composition was changed to a monomer composition consisting of 6.88 g of glycidyl methacrylate (manufactured by Mitsubishi Rayon Co., Ltd.), 1.38 g of glycerol monomethacrylate (manufactured by NOF CORPORATION), 3.03 g of trimethylolpropane trimethacrylate (manufactured by Sartomer USA LLC.), and 2.48 g of polyethylene glycol #400 dimethacrylate (manufactured by Shin Nakamura Chemical Co., Ltd., 9G).

The volume average particle diameter of the filler 3 for affinity chromatography was 67 μm and the specific surface area thereof was 92 m²/g.

### Example 4

A filler 4 for affinity chromatography was obtained by the same operations as in Examples 1-1 to 1-3, except that the monomer composition was changed to a monomer composition consisting of 6.87 g of glycidyl methacrylate (manufactured by Mitsubishi Rayon Co., Ltd.), 1.37 g of glycerol monomethacrylate (manufactured by NOF CORPORATION), 4.12 g of trimethylolpropane trimethacrylate (manufactured by Sartomer USA LLC.), and 1.37 g of methoxypoly ethyleneglycol #400 methacrylate (manufactured by Shin Nakamura Chemical Co., Ltd., M-90G).

The volume average particle diameter of the filler 4 for affinity chromatography was 70 μm and the specific surface area thereof was 94 m²/g.

### Example 5

A filler 5 for affinity chromatography was obtained by the same operations as in Examples 1-1 to 1-3, except that the monomer composition was changed to a monomer composition consisting of 7.41 g of glycidyl methacrylate (manufactured by Mitsubishi Rayon Co., Ltd.), 1.37 g of glycerol monomethacrylate (manufactured by NOF CORPORATION), and 4.94 g of trimethylolpropane trimethacrylate (manufactured by Sartomer USA LLC.), the used amount of 2,2′-azoisobutyronitrile was changed from 0.53 g to 0.93 g, and the added amount of thioglycerol in (2) of Example 1-1 was changed from 31.39 g to 56.37 g. The addition step of thioglycerol was regarded as (2) of Example 5.

The volume average particle diameter of the filler 5 for affinity chromatography was 67 m and the specific surface area thereof was 95 m²/g.

### Comparative Example 1

A filler 6 for affinity chromatography was obtained by the same operations as in Examples 1-1 to 1-3, except that the addition of thioglycerol in (2) of Example 1-1 and sulfoxidation using hydrogen peroxide (step of Example 1-2) were not performed.

The volume average particle diameter of the filler 6 for affinity chromatography was 86 μm and the specific surface area thereof was 97 m²/g.

### Comparative Example 2

A filler 7 for affinity chromatography was obtained by the same operation as in Example 5, except that the addition of thioglycerol in (2) of Example 5 and sulfoxidation using hydrogen peroxide (step of Example 1-2) were not performed. The volume average particle diameter of the filler 7 for affinity chromatography was 74 μm and the specific surface area thereof was 95 m²/g.

### Test Example 1

### Test for Measuring Dynamic Binding Capacity (DBC)

The DBC of the fillers 1 to 7 of Examples 1 to 5 and Comparative Examples 1 and 2 with respect to a protein (human IgG antibody, HGG-1000 manufactured by Equitech Bio, Inc.) was measured at a linear flow rate of 60 cm/hr by using AKTAprime plus manufactured by GE Healthcare. The column container having a capacity of 4 mL (5 mm#×200 mm in length) was used, the protein diluted to 25 mg/mL with an aqueous solution (pH 7.5) of 20 mM sodium phosphate/150 mM sodium chloride was used, and the container was filled with 4 mL of the filler. The DBC was calculated from the captured amount of the protein and the column filling volume at an elution peak of 10% breakthrough. The results thereof are presented in Table 1.

### Test Example 2

### Test for Antifouling Properties

Into a syringe column (inner diameter of 1.5 cm), each of 2 mL of the fillers 1 to 7 of Example 1 to 5 and Comparative Examples 1 and 2 was filled, it was replaced with an aqueous solution (pH 7.5) of 20 mM sodium phosphate/150 mM sodium chloride, and then 10 mL of aqueous solution (pH 7.5) of 20 mM sodium phosphate/150 mM sodium chloride in which a phenol red was dissolved such that the concentration became 0.0015% by mass, was allowed to flow.

Subsequently, washing was carried out with 10 mL of aqueous solution (pH 7.5) of 20 mM sodium phosphate/150 mM sodium chloride, 10 mL of aqueous solution (pH 3.2) of 50 mM sodium citrate and 10 mL of aqueous solution (pH 7.5) of 20 mM sodium phosphate/150 mM sodium chloride were allowed to sequentially flow. Next, 10 mL of aqueous solution of 0.5 M sodium hydroxide was allowed to flow, and the antifouling properties of the fillers were visually evaluated in accordance with the following evaluation criteria. The results thereof are presented in Table 1.

### (Antifouling Properties Evaluation Criteria)

4: Coloration cannot almost be recognized.

3: Coloration can be recognized slightly.

2: Coloration can be recognized.

1: Severe coloration can be recognized clearly.

TABLE 1

| | | | | | | Thioglycerol | | | |
|---|---|---|---|---|---|---|---|---|---|
| | | | | | | treatment | | | |
| | Monomer composition | | | | | before | | | |
| | (part by mass) | | | | | Protein A | | DBC | Antifouling |
| | GMA | GLM | TMP | PEGDM | MPEGM | fixation | Sulfoxidataion | (mg/mL) | properties |
| Example 1 | 50 | 10 | 30 | 10 | 0 | Performed | Performed | 60 | 3 |
| Example 2 | 50 | 10 | 30 | 10 | 0 | Performed | Not performed | 57 | 2 |
| Example 3 | 50 | 10 | 22 | 18 | 0 | Performed | Performed | 60 | 4 |
| Example 4 | 50 | 10 | 30 | 0 | 10 | Performed | Performed | 58 | 4 |
| Example 5 | 54 | 10 | 36 | 0 | 0 | Performed | Performed | 53 | 4 |
| Comparative | 50 | 10 | 30 | 10 | 0 | Not | Not performed | 46 | 1 |
| Example 1 | | | | | | performed | | | |
| Comparative | 54 | 10 | 36 | 0 | 0 | Not | Not performed | 45 | 1 |
| Example 2 | | | | | | performed | | | |

GMA: glycidyl methacrylate,
GLM: glycerol monomethacrylate,
TMP: trimethylolpropane trimethacrylate,
PEGDM: polyethylene glycol #400 dimethacrylate,
MPEGM: methoxypolyethylene glycol #400 methacrylate

From the results of Test Examples 1 and 2 on the filler 2 of Example 2 and the filler 6 of the Comparative Example 1, it found that, when the thioglycerol treatment was performed before the Protein A fixation and the thioglycerol-treated particles were used as a solid-phase carrier, the obtained filler had large DBC and excellent antifouling properties.

Further, from the results of Test Examples 1 and 2 on the filler 1 of Example 1 and the filler 6 of the Comparative Example 1, it found that, when the thioglycerol-treated particles were sulfoxidated before the Protein A fixation and the sulfoxidated particles were used as a solid-phase carrier, the obtained filler had large DBC and excellent antifouling properties.

### Example 6

(1) A monomer composition consisting of 8.23 g of glycidyl methacrylate (manufactured by Mitsubishi Rayon Co., Ltd.), 1.37 g of glycerol monomethacrylate (manufactured by NOF CORPORATION), and 4.12 g of trimethylolpropane trimethacrylate (manufactured by Sartomer USA LLC.) was dissolved in a mixed solution of 20.63 g of 2-octanone (manufactured by Toyo Gosei Co., Ltd.) and 5.30 g of acetophenone (manufactured by INOUE PERFUMERY MFG. CO., LTD.) to prepares a monomer solution (M-2).

Subsequently, the entire amount of the aqueous solution (S-1) prepared in the same manner as in Example 1-1 was fed into a 500 mL separable flask, the separable flask was equipped with a thermometer, a stirring blade, and a cooling tube and was set to a hot water bath, and stirring was started under a nitrogen atmosphere. The entire amount of the monomer solution (M-2) was fed into the separable flask, the separable flask was heated by the hot water bath, 0.53 g of 2,2′-azoisobutyronitrile (manufactured by Wako Pure Chemical Industries, Ltd.) was added thereto when the internal temperature reached 85° C., and the internal temperature was maintained at 86° C.

(2) Thereafter, 6.26 g of thioglycerol (manufactured by ASAHI KAGAKU KOGYO Co., Ltd.) was added to the reaction solution, and while the temperature was maintained at 86° C., stirring was performed for 3 hours so that the polymerization reaction was performed in the presence of thioglycerol.

(3) Subsequently, the reaction solution was cooled, and then this reaction solution was filtered and washed with pure water and ethanol. The washed particles were dispersed in pure water and decantation was carried out three times to remove small particles. Then, the particles were dispersed in pure water such that the concentration of the particles became 10% by mass. This dispersion solution was used as a thioglycerol-treated particle dispersion solution (L-3).

(4) After 4.30 g of hydrogen peroxide (manufactured by Wako Pure Chemical Industries, Ltd.) was added to the thioglycerol-treated particle dispersion solution (L-3), inversion mixing was performed for 24 hours at 25° C. so that the particles were sulfoxidated. Thereafter, this reaction solution was filtered and washed with pure water. Subsequently, the particles were dispersed in pure water such that the concentration of the particles became 10% by mass. This dispersion solution was used as a sulfoxidated particle dispersion solution (L-4).

(5) 0.15 g of modified Protein A represented by amino acid sequence of SEQ ID NO. 2 which was prepared by introducing a vector where DNA containing the base sequence represented by SEQ ID NO. 1 was inserted in pET-24(a) in a host (Escherichia coli BL21 (DE3)) and in which genetically modified Escherichia coli was expressed, was dispersed in 40 mL of buffer (pH 6.6) of 1.0 M trisodium citrate/0.1 M sodium phosphate to obtain a Protein A dispersion solution. The sulfoxidated particle dispersion solution (L-4) (1 g in terms of dry particle mass) was added to this Protein A dispersion solution. This dispersion solution was stirred with shaking for 5 hours at 25° C. to fix Protein A to the particles.

The generated Protein A-fixed particles were washed with a 0.1 M sodium phosphate buffer (pH 7.6) and then dispersed in 40 mL of aqueous solution (pH 8.3) of 1.0 M thioglycerol/0.1 M sodium sulfate, and stirring with shaking was carried out for 17 hours at 25° C. so that an unreacted epoxy group was ring-opened by an excessive amount of thioglycerol.

Thereafter, washing was sequentially performed with a 0.1 M sodium phosphate buffer (pH 7.6), a 0.5 M sodium hydroxide aqueous solution, and a 0.1 M sodium citrate buffer (pH 3.2) to obtain a filler 8 for affinity chromatography.

### Example 7

A filler 9 for affinity chromatography was obtained by the same operation as in Example 6, except that the composition of the monomer composition was changed to 8.87 g of glycidyl methacrylate, 1.48 g of glycerol monomethacrylate, and 4.44 g of glycerin dimethacrylate (manufactured by Shin Nakamura Chemical Co., Ltd.) in the part of Step (1) of Example 6 and the addition of thioglycerol was changed to the addition of 4.88 gof 2-mercaptoethanol (manufactured by Tokyo Chemical Industry Co., Ltd.) in the part of Step (2).

### Example 8

A filler 10 for affinity chromatography was obtained by the same operation as in Example 6, except that the composition of the monomer composition was changed to 8.79 g of glycidyl methacrylate, 1.46 g of glycerol monomethacrylate, and 4.40 g of ethylene glycol dimethacrylate (manufactured by Shin Nakamura Chemical Co., Ltd.) in the part of Step (1) of Example 6 and the addition of thioglycerol was changed to the addition of 5.43 g of 3-mercapto-2-butanone (manufactured by Tokyo Chemical Industry Co., Ltd.) in the part of Step (2).

### Example 9

A filler 11 for affinity chromatography was obtained by the same operation as in Example 6, except that the composition of the monomer composition was changed to 8.86 g of glycidyl methacrylate, 0.74 g of glycerol monomethacrylate (manufactured by NOF CORPORATION), and 5.17 g of trimethylolpropane trimethacrylate in the part of Step (1) of Example 6, the addition of thioglycerol was changed to the addition of 4.81 g of 3-mercapto-1-propanol (manufactured by Tokyo Chemical Industry Co., Ltd.) in the part of Step (2), and sulfoxidation of particles in Step (4) was not performed.

### Example 10

The same operations as in Steps (1) and (2) of Example 6 were performed, except that the composition of the monomer composition was changed to 7.41 g of glycidyl methacrylate, 1.48 g of glycerol monomethacrylate, and 5.93 g of trimethylolpropane trimethacrylate in the part of Step (1) of Example 6. Subsequently, the reaction solution was cooled to 25° C., 45.56 g of 3,6-dioxa-1,8-octanedithiol (manufactured by MARUZEN CHEMICAL TRADING CO., LTD.) was added thereto, and the resultant solution was stirred for 30 minutes. Thereafter, the resultant mixture was heated again by a hot water bath, and while stirring was performed for 5 hours at the time point when the internal temperature reached 85° C., the temperature was maintained at 85° C. Thus, crosslinking was carried out using 3,6-dioxa-1,8-octanedithiol.

Thereafter, the same operations as in Steps (3) to (5) of Example 6 were performed to obtain a filler 12 for affinity chromatography.

### Example 11

A filler 13 for affinity chromatography was obtained by the same operation as in Example 6, except that the composition of the monomer composition was changed to 7.41 g of glycidyl methacrylate, 1.48 g of glycerol monomethacrylate, and 5.93 g of trimethylolpropane trimethacrylate in the part of Step (1) of Example 6 and the addition of thioglycerol was changed to the addition of 6.96 g of 3-mercaptoisobutyric acid in the part of Step (2).

### Comparative Example 3

A filler 14 for affinity chromatography was obtained by the same operation as in Example 6, except that the addition of thioglycerol in Step (2) was not performed after Step (1) of Example 6, the reaction solution was cooled to 25° C., and the same crosslinking as in Example 10 was carried out by adding 45.56 g of 3,6-dioxa-1,8-octanedithiol.

### Comparative Example 4

A filler 15 for affinity chromatography was obtained by the same operation as in Example 7, except that the addition of thioglycerol in Example 7 and sulfoxidation using hydrogen peroxide (Step (4) of Example 6) were not performed.

### Test Example 3

### Measurement of Average Particle Diameter

The average particle diameter (volume average particle diameter) of the filler for affinity chromatography obtained in Examples 6 to 11 and Comparative Examples 3 and 4 was measured by a laser diffraction scattering type particle size distribution analyzer (LS13320 manufactured by Beckman Coulter, Inc.). The results thereof are presented in Table 2.

### Test Example 4

### Quantitative Determination of Binding Amount of Protein A

The binding amount of Protein A as a ligand bound to the filler for affinity chromatography obtained in Examples 6 to 11 and Comparative Examples 3 and 4 was quantitatively determined by using a bicinchoninic acid (BCA) reagent. Specifically, 1 mg of a filler in terms of the solid content was collected in a test tube, and this was quantitatively determined by using a BCA Protein Assay Kit manufactured by Thermo Fisher Scientific K.K. The reaction was carried out by inversion mixing for 30 minutes at 37° C. The calibration curve was established by using the same samples as Protein Abound to the carrier. The results thereof are presented in Table 2.

### Test Example 5

### Test for Measuring Dynamic Binding Capacity (DBC)

The DBC of each filler of Examples 6 to 11 and Comparative Examples 3 and 4 with respect to a protein (human IgG antibody, HGG-1000 manufactured by Equitech Bio, Inc.) was measured at a linear flow rate of 300 cm/hr by using AKTAprime plus manufactured by GE Healthcare. The column container having a capacity of 4 mL (5 mmφ×200 mm in length) was used, the protein diluted to 5 mg/mL with an aqueous solution (pH 7.5) of 20 mM sodium phosphate/150 mM sodium chloride was used, and the container was filled with 4 mL of the filler. The DBC was calculated from the captured amount of the protein and the column filling volume at an elution peak of 10% breakthrough. The results thereof are presented in Table 2.

### Test Example 6

### Quantitative Determination of HCP

Each filler of Examples 6 to 11 and Comparative Examples 3 and 4 was filled in a column container (Tricorn 10/50 column manufactured by GE Healthcare) at a filling height of about 5 cm to prepare a column. The obtained columns each were connected to AKTA Prime Plus manufactured by GE Healthcare, a 20 mM sodium phosphate buffer (pH 7.5) was allowed to flow at a column capacity of 5 (corresponding to five times the column volume) and a flow rate of 1 mL/min, and equilibrating was carried out. Subsequently, CHO cell culture supernatant containing a monoclonal antibody, Trastuzumab, was allowed to flow through the column at a load amount of about 23 mg antibody/mL carrier and at a flow rate of 1 mL/min.

Subsequently, a 20 mM sodium phosphate buffer (pH 7.5), a buffer (pH 7.5) of 20 mM sodium phosphate/1 M sodium chloride, and a 20 mM sodium phosphate buffer (pH 7.5) each were allowed to sequentially flow through the column at a column capacity of 5 and a flow rate of 1 mL/min.

Thereafter, a 50 mM sodium citrate buffer (pH 3.2) was allowed to flow through the column at a flow rate of 1 mL/min, the monoclonal antibody captured in the column was eluted, and then Abs. 280>100 mAu of eluted fraction was recovered. Then, the concentration (mg/mL) of the antibody contained in the recovered fraction was measured by using a spectrophotometer. Further, the concentration of the host cell protein (HCP) contained in the recovered fraction was measured by using CHO HCP ELISA kit, 3G manufactured by Cygnus Technologies Inc. Furthermore, the amount of HCP per unit antibody amount was calculated by dividing the concentration of HCP by the antibody concentration. The results thereof are presented in Table 2.

TABLE 2

| | | | | | | | | Post- | | Average | PrA | | |
|---|---|---|---|---|---|---|---|---|---|---|---|---|---|
| | | | | | | | | cross- | | particle | binding | | |
| | | Monomer | | | | | | linking | | diameter | amount | DBC | HCP |
| | | GMA | GLM | TMP | GLDM | EDMA | Thiol | agent | Oxidant | (μm) | (mg/g) | (mg/mL) | (ppm) |
| Example | 6 | 60 | 10 | 30 | — | — | Thioglycerol | None | H₂O₂ | 64 | 63 | 38.2 | 1103 |
| | 7 | 60 | 10 | — | 30 | — | 2-Mercaptoethanol | None | H₂O₂ | 69 | 66 | 39.1 | 1056 |
| | 8 | 60 | 10 | — | — | 30 | 3-Mercapto-2-butanone | None | H₂O₂ | 58 | 60 | 40.2 | 1098 |
| | 9 | 60 | 5 | 35 | — | — | 3-Mercapto-1-propanol | None | None | 71 | 67 | 38.8 | 1293 |
| | 10 | 50 | 10 | 40 | — | — | Thioglycerol | DMDO | H₂O₂ | 65 | 70 | 37.4 | 1171 |
| | 11 | 50 | 10 | 40 | — | — | 3-Mercaptoisobutyric acid | None | H₂O₂ | 65 | 72 | 39.4 | 1100 |
| Comparative | 3 | 60 | 10 | 30 | — | — | None | DMDO | H₂O₂ | 66 | 59 | 34.1 | 2582 |
| Example | 4 | 60 | 10 | — | 30 | — | None | None | None | 63 | 62 | 30.1 | 1748 |

GMA: glycidyl methacrylate
GLM: glycerol monomethacrylate
TMP: trimethylolpropane trimethacrylate
GLDM: glycerin dimethacrylate
EDMA: ethylene glycol dimethacrylate
DMDO: 3,6-dioxa-1,8-octanedithiol

From the results of Test Examples 5 and 6 on the fillers of Examples 6 to 11 and the fillers of Comparative Examples 3 and 4, it found that, when thioether was added during polymerization and a hydrophilic group was introduced in the terminal of the chain through a thio group, an excellent filler having large DBC and reduced HCP could be obtained.

1: A solid-phase carrier comprising:
a functional group capable of fixing a ligand; and
a group comprising:
a first component selected from the group consisting of a sulfinyl group, a sulfide group, an oxy group and an imino group; and
a second component selected from the group consisting of a hydroxyl group, a thiol group, an amino group, a carboxy group, a sulfate group, a phosphate group and an alkanoyl group.

2: The solid-phase carrier according to claim 1, wherein the functional group capable of fixing a ligand is a cyclic ether group, a carboxy group, a succinimidoxy group, a formyl group, an isocyanate group or an amino group.

3: The solid-phase carrier according to claim 2, wherein the functional group capable of fixing a ligand is the cyclic ether group, and
the cyclic ether group is a group represented by Formula (1-1), (1-2) or (1-3): 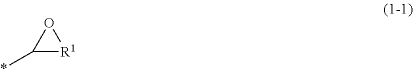 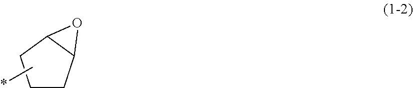 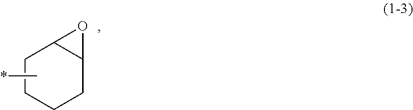
wherein
R¹ represents a divalent hydrocarbon group having 1 to 6 carbon atoms, and
* represents a bond.

4: The solid-phase carrier according to claim 1, wherein the second component is the hydroxyl group.

5: The solid-phase carrier according to claim 1, wherein the group comprising the first component and the second component is a group represented by Formula (2-1), (2-2) or (2-3): 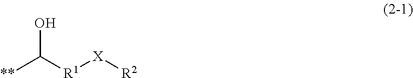 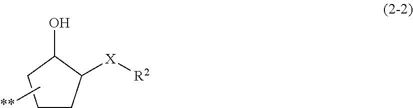 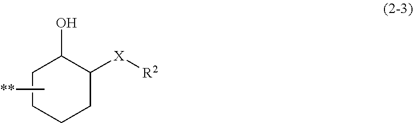
wherein
R¹ represents a divalent hydrocarbon group having 1 to 6 carbon atoms,
R² represents a monovalent organic group having 1 to 10 carbon atoms,
X represents a sulfinyl group a sulfide group an oxy group or an imino group, and
** represents a bond.

6: The solid-phase carrier according to claim 5, wherein R² is a monovalent organic group represented by Formula (3): 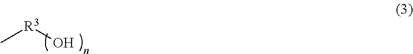
wherein R³ represents a divalent or trivalent organic group having 1 to 10 carbon atoms, and
n represents 1 or 2.

7: The solid-phase carrier according to claim 5, wherein X is a sulfinyl group or a sulfide group.

8: The solid-phase carrier according to claim 1, wherein the solid-phase carrier is a porous polymer particle.

9: A method for producing a solid-phase carrier, the method comprising;
bringing a solid-phase carrier having a functional group capable of fixing a ligand into contact with a compound represented by Formula (4):
R²—Y—H (4)
wherein
R² represents a monovalent organic group having 1 to 10 carbon atoms, and
Y represents a sulfide group, an oxy group or an imino group, and
wherein the solid-phase carrier comprises a functional group capable of fixing a ligand and a group represented by Formula (5-1), (5-2) or (5-3): 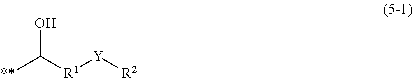 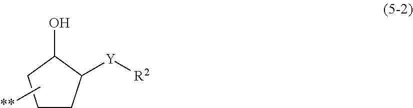 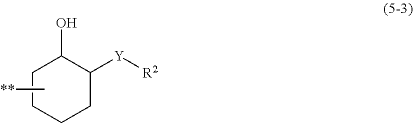
wherein
R¹ represents a divalent hydrocarbon group having 1 to 6 carbon atoms,
R² represents a monovalent organic group having 1 to 10 carbon atoms, and
** represents a bond.

10: The production method according to claim 9, wherein Y is a sulfide group.

11: The production method according to claim 10, further comprising,
bringing the solid-phase carrier having the functional group capable of fixing a ligand and the group represented by Formula (5-1), (5-2) or (5-3) into contact with an oxidant to obtain a solid-phase carrier having a functional group capable of fixing a ligand and a group represented by Formula (6-1), (6-2) or (6-3): 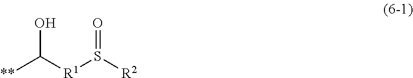 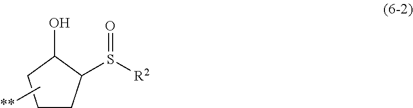 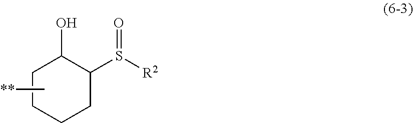
wherein
R¹ represents a divalent hydrocarbon group having 1 to 6 carbon atoms,
R² represents a monovalent organic group having 1 to 10 carbon atoms, and
** represents a bond.

12: The production method according to claim 9, wherein the functional group is represented by Formula (1-1), (1-2) or (1-3): 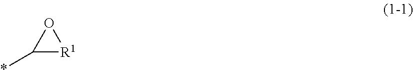 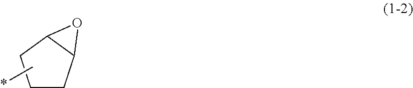 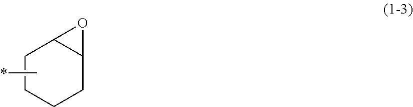
wherein
R¹ represents a divalent hydrocarbon group having 1 to 6 carbon atoms, and
* represents a bond.

13: A method for producing a filler the method comprising,
fixing a ligand to the solid-phase carrier according to claim 1.

14: The production method according to claim 13, wherein the ligand is a protein or a peptide.

15: A filler obtained by the production method according to claim 13.

16: A carrier comprising
a solid-phase carrier comprising a polymer and
a ligand or a reactive group for binding a ligand,
wherein
the ligand or the reactive group for binding a ligand is bound to the solid-phase carrier, and
the polymer has a terminal structure having at least one group selected from the group consisting of a hydroxyl group, a thiol group, a carbonyl group, an amino group, a thio group, a disulfide group, a sulfinyl group, a sulfonyl group, a carboxy group, a sulfate group, and a phosphate group, in the terminal of a polymer chain through a thio group, a sulfinyl group or a sulfonyl group.

17: The carrier according to claim 16,
wherein the terminal structure is represented by Formula (21): 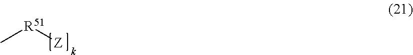
wherein
R⁵¹ represents an organic group having 1 to 20 carbon atoms,
Z represents a hydroxyl group, a thiol group, an amino group, a carboxy group, a sulfate group, a phosphate group or an alkanoyl group, and
k represents an integer of 1 or more.

18: The carrier according to claim 17, wherein Z is a hydroxyl group, a thiol group, a carboxy group, a sulfate group or an alkanoyl group.

19: The carrier according to claim 17, wherein k is an integer of 1 to 5.

20: The carrier according to any-ene claim 16, wherein the terminal structure is introduced by adding a thiol compound before or during polymerization of the solid-phase carrier.

21: The carrier according to claim 16, wherein the polymer constituting the solid-phase carrier is a polymer having a structural unit derived from at least one monomer selected from the group consisting of a styrene-based monomer, a vinyl ketone-based monomer, a (meth)acrylonitrile-based monomer, a (meth)acrylate-based monomer, and a (meth)acrylamide-based monomer.

22: The carrier according to claim 16, wherein the solid-phase carrier further comprises a cross-linked structure derived from a cross-linking agent represented by Formula (22):
X¹¹—R⁵²—X¹² (22)
wherein
R⁵² represents a divalent organic group having 1 to 10 carbon atoms, and
X¹¹ and X¹² independently represent a hydroxyl group, an amino group or a thiol group.

23: The carrier according to claim 22, wherein X¹¹ and X¹² are a thiol group.

24: The carrier according to claim 23, obtained by oxidizing a thio group in the cross-linked structure.

25: The carrier according to claim 16, wherein the ligand or the reactive group for binding a ligand is a ligand.

26: The carrier according to claim 25, wherein the ligand is an immunoglobulin-binding protein.

27: A filler for a chromatography comprising the carrier according to claim 16.

28: A chromatography column, formed by filling a column container with the filler according to claim 15.

29: A method for refining a target substance, the method comprising:
preparing a composition comprising a target substance; and
passing the composition through the chromatography column according to claim 28.

30: The refining method according to claim 29, wherein the target substance is a protein.

31: A method for producing a filler, the method comprising,
fixing a ligand to a solid-phase carrier produced by the production method according to claim 9.

32: A filler obtained by the production method according to claim 31.
